(19) United States
(12) Patent Application Publication
(10) Pub. No.: US 2024/0040960 A1
(43) Pub. Date: Feb. 8, 2024

(54) SYSTEMS AND METHODS FOR ELECTRICALLY POWERED MOWERS

(71) Applicant: Clark Equipment Company, West Fargo, ND (US)

(72) Inventors: Brian Dehnert, Mandon, ND (US); Matt Keller, Bismarck, ND (US); Mike Agurkis, Madison, WI (US); Jonathan Roehrl, Bismarck, ND (US)

(21) Appl. No.: 18/365,584

(22) Filed: Aug. 4, 2023

Related U.S. Application Data
(60) Provisional application No. 63/395,509, filed on Aug. 5, 2022.

(51) Int. Cl. A01D 34/00; A01D 34/64; A01D 34/78; B60L 58/26; B60L 53/22; H05K 7/20

(52) U.S. Cl. CPC A01D 34/006; A01D 34/64; A01D 34/78; B60L 58/26; B60L 53/22; H05K 7/20145; H05K 7/20909; H05K 7/20945; A01D 2101/00

(57) ABSTRACT

The disclosed technology provides systems and methods for power machines, including electrically powered mowers. A mower can be provided with a cooling system that produces a cooling airflow within a mower frame to extract heat from power electronics. A mower can include control assemblies with an adjustable neutral position to improve inter-operation of braking and tractive controls. A cutting assembly for a mower can include an adapter configured to allow a blade to rotate independently of a motor spindle when a transmitted torque is above a threshold torque value.

### CROSS-REFERENCE TO RELATED APPLICATIONS

This application claims priority to and incorporates by reference U.S. Provisional Patent Application No. 63/395,509, filed Aug. 5, 2022.

### BACKGROUND

This disclosure is directed toward power machines. More particularly, this disclosure is related to power machines for mowing operations, including zero-turn mowers, that are configured to operate in whole or in part under electrical power. Power machines, for the purposes of this disclosure, include any type of machine that generates power to accomplish a particular task or a variety of tasks. One type of power machine is a work vehicle. Work vehicles are generally self-propelled vehicles that have a work device that can be operated to perform a work function. For example, mowers can include a mower deck with one or more rotatable blades that can be operated to cut grass, brush, or other material as the mower travels over terrain. Other work vehicles include loaders (including mini-loaders), excavators, utility vehicles, tractors (including compact tractors), and trenchers, to name a few examples.

Conventional power machines can include hydraulic or mechanical systems that are configured to transmit power from a power source (e.g., an internal combustion engine) to perform various work functions. For example, a power source can be configured to provide tractive power for moving a power machine along a support surface, as well as powering various work implements (e.g., to rotate a blade). Still, other power machines can include a power source (e.g., a battery) configured to provide electrical power to perform work functions, for example, by driving an electric motor or operating an electrical actuator.

The discussion above is merely provided for general background information and is not intended to be used as an aid in determining the scope of the claimed subject matter.

### SUMMARY

Examples of the presently disclosed technology can provide improvements for power machines, including power machines equipped with an electrical power source (e.g., a battery) that is configured to provide electrical power to perform various work functions. During charging, it can be advantageous to cool a battery (or other power source) and any corresponding power electronics (e.g., a charger, power distribution unit, AC/DC or DC/DC convertors, etc.) to prevent overheating. Accordingly, a fan can be operated during charging to draw ambient air through a frame of a power machine and across various electrical components to remove excess heat. In some cases, a fan can also be operated when performing one or more functions of the power machine, for example, to cool a battery, a traction motor, or other power electronic components. In some cases, certain advantageous arrangements of components can be provided for charging and cooling operations, including arrangements of internal structures for cooling airflow paths, and arrangements of chargers on sub-assemblies that can be collectively installed on a power machine during manufacturing. In some cases, a combination of destructive and non-destructive or other torque transfer engagements with different yield torques can be provided between different components of a cutting assembly.

According to some aspects of the disclosure, a mower can include a main frame. A cutting assembly can be supported by the main frame (e.g., between the front end and the back end) to cut plant material during operation of the mower. The main frame can further include a first electronics bay and a second electronics bay. One or more first power electronic devices can be housed within the first electronic bay, and an electrical power source and one or more second power electronic devices can be housed within the second electronics bay. A flow path for cooling airflow can be defined by the mower to extend from an air inlet, through the first electronics bay to the second electronics bay, and from the second electronics bay to an air outlet, thereby cooling the first power electronics, the electrical power source, and the second power electronics.

In some examples, the air inlet can provide an upward air flow along the flow path from outside the mower to an interior space of the mower. The air outlet can provide a downward air flow along the flow path from the second electronics bay to outside the mower.

In some examples, the air inlet can be disposed on a bottom side of the main frame. The air inlet can be separated from the first electronics bay by one or more baffle walls to provide the upward air flow.

In some examples, an outlet fan can be supported at a bottom wall of the second electronics bay and arranged to direct the downward air flow to be vented away from the mower through the air outlet.

In some examples, the one or more first power electronic devices can include one or more of an inverter arranged to power operational rotation of the cutting assembly, an inverter for a traction motor, a power distribution unit, an auxiliary battery, or a fuse box.

In some examples, the one or more second power electronic devices can include a first charger for the electrical power source, arranged to the rear of the electrical power source. The outlet fan can be located vertically below the first charger to direct the downward air flow past the first charger.

In some examples, one or more second power electronic devices can further include a second charger for the electrical power source. The electrical power source can be spaced laterally from the first charger to define a vertical flow channel for the downward air flow. The vertical flow channel can extend along the flow path, between the first and second chargers, to the outlet fan.

In some examples, the electrical power source can be disposed between the one or more first power electronic devices in the first electronics bay and the one or more second power electronic devices in the second electronics bay. The flow path can include a power-source cooling sub-path that extends from the first electronics bay to the one or more power electronics devices in the second electronics bay. The path can also include the power-source cooling sub-path extending one or more of over a top side of the electrical power source or around one or more lateral sides of the electrical power source.

In some examples, a top side of the electrical power source can be located vertically below a top portion of the main frame. The top side of the electrical power source can further be located vertically below an operator seat supported on the main frame. The first electronics bay can be aligned vertically below the operator seat.

According to some aspects of the disclosure, a method for cooling a power machine can include operating a fan at a rear end of the power machine to cause a cooling airflow from a cooling inlet provided at a front end of the power machine to the fan. The cooling airflow can flow along a cooling flow path between the inlet and the fan. The cooling airflow can flow upwardly from the cooling inlet to circulate within a first locally enlarged area that houses first electronics of the power machine and is downstream of the cooling inlet. The cooling airflow can pass from the first locally enlarged area and through a cooling restriction that can be downstream of the first electronics bay. The cooling restriction can be defined at least in part by a power source of the power machine (e.g., a battery) that is arranged to be cooled by the cooling airflow. From the cooling restriction, the cooling airflow can flow into and circulate within a second locally enlarged area that houses second electronics of the power machine. Within the second locally enlarged area, the cooling air can flow downwardly to the fan to be directed to the ambient surroundings to reject heat from the first and second electronics and the power source.

In some examples, the power machine can be a mower with a cutting assembly, and the cooling inlet can be aligned vertically above the cutting assembly. The first locally enlarged area can be aligned vertically below an operator seat of the mower.

In some examples, the power source can be an electrical power source. The cooling restriction can define a flow area for the cooling airflow to flow along at least one of a top side of the electrical power source or one or more lateral sides of the electrical power source.

In some examples, the power machine of the mower can include one or more electronic drive motors. The cooling restriction can define the flow area for cooling airflow along the one or more lateral sides of the electrical power source, so that the flow area can extend along the one or more electronic drive motors. Hence, the cooling airflow can cool the one or more electronic drive motors along the cooling restriction.

In some examples, the power source of the mower can be a rechargeable electrical power source. The second electronics can include a charger for the rechargeable electrical power source arranged to the rear of the rechargeable electrical power source. The fan can be automatically controlled to continuously (e.g., always) provide the cooling airflow during operation of the charger to charge the rechargeable electrical power source.

In some examples, the power machine can be a mower with a cutting assembly. The fan can be automatically controlled to provide the cooling airflow based on one or more cooling criteria for one or more of a motor, an inverter, or an electrical power source of the mower.

According to some aspects of the disclosure, a mower can include a main frame. The mower can further include a drive assembly having one or more electric drive motors and a cutting assembly having one or more electric cutting motors. The cutting assembly can be supported by the main frame to cut plant material during operation of the mower. An electrical power source can be configured to provide operational power for the one or more electric drive motors and the one or more electric cutting motors. Further, a charger can be supported on the main frame to charge the electrical power source using current from an external power source.

In some examples, the charger can be secured to a support plate that is removably and adjustably secured to the main frame rearward of the electrical power source.

In some examples, the charger can be a first charger, which can be laterally spaced from a second charger on the support plate to provide a vertical channel for cooling airflow between the first and second chargers. The second charger can be secured to the support plate.

According to some aspects of the disclosure, a mower of a sub-assembly can include a main frame and an electrical power source. The sub-assembly can include a support plate. The sub-assembly can further include a first charger for the electrical power source and a second charger for the electrical power source. The first and second chargers can be secured on the support plate to be collectively installed onto the mower with the support plate.

In some examples, the sub-assembly can further include a first charger, a second charger, a DC/DC converter, a communication module, and a hub controller secured to the support plate to be collectively installed onto the mower with the support plate. On first side of the support plate, the hub controller can be secured at a first end of the support plate. The first charger can be secured at a second end of the support plate, and the second charger can be secured between the hub controller and the first charger. The DC/DC converter can be secured between the first and second chargers. In some examples, on a second side of the sub-assembly's support plate, the communication module can be secured at the first end of the support plate and directly opposite the hub controller.

According to some aspects of the disclosure, a method of assembly for a mower can include installing an electrical power source onto a main frame of the mower. The electrical power source can provide electrical power to one or more motors of the mower. The method can further include pre-assembling a charging sub-assembly and installing the pre-assembled charging sub-assembly onto the main frame. The charging subassembly can include a support plate, a first charger for the electrical power source, and an electrical power source.

In some examples, the support plate can include a first side with a first angled flange and a second side opposite the first side. The step of installing the pre-assembled charging sub-assembly onto the main frame can include securing the first flange to a fixed location on a side wall of the main frame. The step can further include adjustably securing the second side of the support plate to an angled mounting flange of the main frame in any of a plurality of positions relative the angled mounting flange. In some examples, the step can include securing the support plate to support the first charger rearward of the electrical power source, with the first charger on an opposite side of the support plate from the electrical power source.

According to some aspects of the disclosure, a control assembly for a mower can include a control lever, a guide plate, and an adjustment plate. The control lever can be supported relative to a main frame of the mower to pivot about a first axis to provide tractive control and to pivot about a second axis to provide brake control. The guide plate can include a first slot to accommodate pivoting of the control lever about the first axis and a second slot to accommodate pivoting of the control lever about the second axis. The second slot can be arranged to receive the control lever when the control lever is moved to activate a brake for the mower. The adjustment plate can include a third slot and can be adjustably secured to the guide plate to be movable to selectively define a sub-slot within the second slot to receive the control lever when the control lever is moved to activate the brake.

In some examples, the first slot can extend in a front-to-back direction of the mower to accommodate the pivoting of the control lever about the first axis. The second slot can extend laterally from the first slot to accommodate the pivoting of the control lever about the second axis.

In some examples, the second slot can have a second-slot front-to-back width. The third slot can have a third-slot front-to-back width that is smaller than the second-slot front-to-back width. The adjustment plate can be adjustably secured to the guide plate with the third slot overlapping the second slot, the second and third slots thereby extend laterally from the first slot and simultaneously receive the control lever when the control lever is moved to activate the brake.

In some examples, the adjustment plate can be adjustably secured to the guide plate using one or more elongated attachment slots so as to be slidably adjustable relative to the guide plate.

According to some aspects of the disclosure, a method of assembling a mower can include installing a control lever on a main frame of the mower to pivot about a first axis to provide tractive control and to pivot about a second axis to provide brake control. The method can also include installing a guide plate of the main frame. The guide plate can include a first slot to accommodate pivoting of the control lever about the first axis and a second slot to accommodate pivoting of the control lever about the second axis. The second slot can be arranged to receive the control lever when the control lever is moved to activate a brake for the mower. The method can further include securing an adjustment plate to the guide plate with a third slot of the adjustment plate overlapping with the second slot. The adjustment plate can be adjusted relative to the guide plate to align the third slot with a neutral band within a range of motion of the control lever.

According to some aspects of the disclosure, a cutting assembly for a mower can include a blade, a motor, and an adapter. The motor can include an output interface configured to provide rotational power to the blade and the adapter can be secured to the output interface to transmit rotational power from the output interface to the blade. The adapter can be secured to the output interface at a first connection. The first connection can provide a first maximum torque-transmission value for transmission of operational torque between the motor and the adapter. The adapter can also be secured to the blade at a second connection. The second connection can provide a second maximum torque-transmission value for transmission of operational torque between the adapter and the blade. The second maximum torque-transmission value can be smaller than the first maximum torque-transmission value.

In some examples, the first connection of the cutting assembly can be configured to yield destructively at the first maximum-torque-transmission value. The first connection can be a keyed connection and include a key that is sized to be sheared off of the first connection at the first maximum torque-transmission value.

In some examples, one or more of the following aspects can be additionally included, individually or in combination. The second connection of the cutting assembly can be configured to yield non-destructively at the second maximum-torque transmission value. The second connection can be a contact-friction connection configured to slip at the second maximum torque-transmission value. The second connection can be formed by a threaded fastener that extends through the blade to compress the blade into frictional torque-transmitting contact with the adapter. The threaded fastener can be configured to secure the blade against removal from the motor after destructive yield of the first connection.

In some examples, the cutting assembly can have a motor that has a maximum rated motor torque, which can be smaller than the second maximum torque-transmission value. Further, the adapter of the cutting assembly can include an annular lip that extends away from the blade to overlap with the output interface, to block entrance of debris into the motor.

According to some aspects of the disclosure, a method of assembling a cutting assembly for a mower can include securing an adapter to an output interface of a motor that is configured to provide rotational power for cutting operations. A blade can be secured to the adapter so that the adapter is arranged to transmit operational torque from the motor to the blade. The adapter can be configured to yield destructively at a first torque value, so as to stop transmitting the operational torque from the motor to the blade for torque values larger than the first torque value. The blade can be configured to slip non-destructively relative to the adapter at a second torque value, so as to stop transmission of torque between the adapter and the blade, the second torque value being smaller than the first torque value.

In some examples, the adapter can be secured to the output interface by providing a keyed connection between the adapter and the motor. The blade can be secured to the adapter by tightening the blade into frictional engagement with the adapter.

In some examples, the adaptor can be secured to the output interface by arranging a lip of the adapter around the output interface. The lip can be extended away from the blade.

This Summary and the Abstract are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter.

### DRAWINGS

FIG. 1 is a block diagram illustrating functional systems of a representative power machine on which examples of the disclosed technology can be advantageously practiced.

FIG. 2 is a perspective view showing generally a front of a power machine in the form of a zero turn mower on which embodiments disclosed in this specification can be advantageously practiced.

FIG. 3 is a block diagram illustrating components of a hydraulic power system of a loader such as the mower of FIG. 2.

FIG. 4 is a partial rear perspective view of a mower according to aspects of the disclosure, with a rear portion of a frame removed to show a power source and charging system of the mower.

FIG. 5 is a partial side view of the mower of FIG. 4 with the frame partially transparent to show the power source of the mower and first and second bays having power electronics therein.

FIG. 6 is a partial top perspective view of the mower of FIG. 4 with a seat removed to show the first electronics bay with first power electronics.

FIG. 7 is a partial rear perspective view of the mower of FIG. 4 with a rear portion of a frame removed to show the second electronics bay with second power electronics.

FIG. 8 is a perspective view of a charging sub-assembly of the mower of FIG. 4, which can be positioned in the second electronics bay.

FIG. 9 is a detail view illustrating a connection between the charging subassembly and the frame of the mower, taken about line IX-IX in FIG. 7.

FIG. 10 is a partial rear perspective view of the mower of FIG. 4 showing a cooling airflow through the mower.

FIG. 11 is a partial section view of the mower of FIG. 4 showing an air inlet for the cooling airflow.

FIG. 12 is a partial side view of the mower of FIG. 4 with the frame partially transparent to show the cooling airflow through the mower and certain components not shown for clarity of presentation.

FIG. 13 is a perspective view of the mower of FIG. 4 with the frame transparent to show the cooling airflow through the mower and certain components not shown for clarity of presentation.

FIG. 14 is a detail view of the mower of FIG. 4 showing a fan that induces the cooling airflow and an outlet for the cooling airflow.

FIG. 15 is a partial perspective view showing a control assembly of the mower of FIG. 4.

FIG. 16 is another partial perspective view of the control assembly of FIG. 15.

FIG. 17 is a detail view of the control assembly of FIG. 15, in isolation from a frame of the mower of FIG. 4.

FIG. 18 is schematic view of a guide plate and an adjustable plate of the control assembly of FIG. 15.

FIG. 19 is a partial perspective view of a mowing deck and cutting assemblies of the mower of FIG. 4.

FIG. 20 is an exploded view of one of the cutting assemblies of FIG. 18.

FIG. 21 is a partial section view of the cutting assembly of FIG. 20.

FIG. 22 is a perspective view of an adapter of the cutting assembly of FIG. 20.

FIG. 23 is a detail view of the cutting assembly of FIG. 20.

### DESCRIPTION

The concepts disclosed in this discussion are described and illustrated by referring to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

In some aspects, the disclosed technology provides improved systems and methods for cooling power electronics and a power source of a mower. In some examples in particular, improved systems and methods are provided for power machines having a power source configured to supply electrical power (e.g., a battery), as opposed to hydraulic or mechanical power, to operate certain power machine components (e.g., drive or workgroup motors) or otherwise implement certain power machine functionality.

For example, a mower can be an electrically-powered mower that can include a battery (or other electrical power source). The battery (or other power source) can be supported within a frame of the mower. More specifically, the battery can be supported within an interior cavity by (or near) a bottom portion of the frame in order to lower a center of gravity of the mower and increase stability. In addition, the battery can be disposed between traction motors that are configured to propel the mower along a support surface. Accordingly, the battery can be positioned inboard of each traction motor. A bottom surface of the battery can be located vertically below a central axis of the traction motors. Further, an upper surface of the battery can be located vertically below an operator station (e.g., a seat) or corresponding portion of the mower frame that is configured to support the operator station, which may prevent the battery from impeding a line of sight of an operator. As will be described in greater detail below, positioning the battery in this way can also provide for improved cooling of the battery and any associated power electronics.

In some cases, a battery or other structure can subdivide an internal cavity of a frame into a first bay (i.e., a front bay) and a second bay (i.e., a rear bay). For example, at least a portion of the battery can be within at least one of the first bay or the second bay. Each of the first bay and the second bay can be configured to hold power electronics for the distribution of electrical current to and from the battery. In particular, the first bay can be configured as a first power electronics bay having first power electronics therein (e.g., an inverter for a motor of a cutting assembly, an inverter for a traction motor, a power distribution unit, an auxiliary battery (e.g., a 12-volt battery), a fuse or relay box, etc.). Similarly, the second bay can be configured as a second power electronics bay having second power electronics therein (e.g., a charger, hub controller, a DC/DC converter, a communication module, etc.).

In some examples, power electronics can be provided as a pre-assembled sub-assembly for installation onto the main frame as a single component. For example, second power electronics can be included in a pre-assembled charging assembly that can be installed into a second bay as a single unit, including as can provide improved manufacturing and packaging efficiency among other benefits. The pre-assembled charging assembly can include a plate that can be configured to be installed in a transverse orientation so that the plate extends between opposing lateral sides of the frame within the second bay (e.g., with a first end of the plate coupled to a first lateral side of the frame and a second end of the plate coupled to a second lateral side frame). The plate can also be oriented substantially vertically or angled slightly forward within the second bay (e.g., angled approximately zero to fifteen degrees from vertical, with a top edge closer to a front end of the mower than is a bottom edge) so that a first side of the plate faces rearward and a second opposing side of the plate faces forward.

The plate of a pre-assembled sub-assembly can be configured to support one or more power electronics within a bay (e.g., second power electronics within a second bay), which can be preinstalled while the plate is outside the second bay. For example, a first side of the plate (e.g., a rear side when installed in the second bay) can be configured to support a controller (e.g., a central or “hub” controller) at a first end of the plate and a charger at a second end of a plate, and a DC/DC converter that can be positioned laterally between the controller and the charger. In some cases, a dual charger assembly can be provided and a second charger can be supported on the first side of the plate, spaced laterally from a first charger and, in some cases, laterally between a DC/DC converter and a hub controller. Further, additional power electronics can be supported on an opposing second side of the plate (e.g., a front side of the plate that is closest to the battery when installed in the second bay). For example, a communication module can be supported on the second side of the plate, and in some cases, directly opposite the hub controller.

To improve charging efficiency and speed, a mower can include a fan assembly that can be operated during a charging procedure to provide a cooling airflow across a charger. The fan assembly can be operated by a controller (e.g., a hub controller) when a charging sequence begins, when a charger reaches a threshold temperature (e.g., approximately 40° C.), or based on other criteria or timing. In particular, the controller can control a supply of electrical current to the fan to cause ambient air to be drawn into an air inlet, through the internal cavity of the frame, across a charger, and out of an air outlet to reject heat from the charger back to the ambient environment. Specifically, the ambient air can be drawn as a cooling upward airflow through an air inlet (e.g., in a bottom of the frame) and into a first bay. This cooling airflow can then flow within the frame generally rearward toward the battery, passing through a gap between a top surface of the battery and the frame (e.g., between the battery and an operator station) to enter a second bay. After entering the second bay the cooling airflow can flow downward to exit the mower through an outlet (e.g., provided in a bottom surface of the frame). In some cases, the downward flow can travel along both sides of a plate to extract heat from any power electronics supported on the plate. For example, cooling air can flow over and between chargers supported on a transverse plate as part of a collectively installed charging sub-assembly (e.g., as also discussed above).

In some embodiments, a fan assembly can also be operated when the mower is performing one or more work operations, to help cool the associated power electronics. In particular, a hub (or other) controller can be configured to operate a fan assembly when one or more power electronic components (e.g., a traction motor, power distribution unit, DC/DC converter, etc.) reaches a threshold temperature. As one particular example, a controller can operate the fan assembly to provide a cooling airflow when a traction motor reaches a threshold temperature. Accordingly, ambient air can be drawn into a first bay through an air inlet. The cooling air can swirl or otherwise circulate within the first bay to cool one or more first power electronics and can pass over the top or along the sides of the battery to exit through an air outlet, providing cooling to the battery. A portion of cooling airflow that passes along the sides of the battery can also pass along a traction motor to extract heat from the traction motor.

Aspects of the disclosed technology can also provide for improved systems and methods for appropriately aligning a neutral position of a control lever of a control assembly (e.g., an operator input device). For example, a control assembly can include a control lever that extends through an opening in a guide plate (e.g., a portion of a main frame) to allow an operator to manipulate the control lever. Specifically, an operator can apply a force to the control lever to pivot the control lever about a first axis to control a direction of travel and to pivot the control lever about a second axis to provide (parking) brake control. Correspondingly, the guide plate can include a first slot to allow the control lever to pivot about the first axis to move between a first end of the first slot (e.g., to rotate a traction element, for example, a wheel, in a first direction) and a second end of the first slot (e.g., to rotate the wheel in an opposite, second direction). Counteracting springs or another type of resilient member can be provided to maintain the control lever in a neutral position between the first end and the second end of the first slot when a force is not applied to the control lever by the operator, so that no tractive command is provided by the lever and the associated wheel is not powered for rotation. From the neutral position, the control lever can be pivoted about the second axis to move laterally in an outboard direction into a second slot. The second slot can extend from the first slot and be positioned to align with the neutral position of the control lever. When the control lever is pivoted into the second slot, a brake switch can be released to engage one or more parking brakes of the mower (or the one or more parking brakes can be otherwise engaged).

To account for manufacturing variability, in which the exact neutral position of the control lever can vary between the first and second ends of the first slot, the second slot can be oversized in some cases (i.e., to have a front-to-back width that can accommodate a range of possible neutral positions). Consequently, conventional control assemblies are generally configured with a wide neutral band (e.g., a range of positions between the first and second ends of the first slot that are considered “neutral,” which surround an exact neutral position of the control lever). When the control lever is perceived to be in the neutral band by a sensor, the wheels of the mower will not be turned by the traction motors. As a result, an operator must move the control lever beyond the neutral band to command movement of the mower. Relatedly, if excessive space around neutral is provided by a brake slot, a lever may sometimes be sensed to have moved out of neutral while a parking brake is engaged, which can result in machine errors or loss of power.

Accordingly, to improve perceived responsiveness of the control assembly (e.g., to reduce the width of the neutral band) and ensure close alignment of a neutral position of a control with a brake (e.g., second) slot, a control assembly can include an adjustment plate that is secured to the guide plate. The adjustment plate can include a third slot that has a narrower width than the second slot, and that overlaps the second slot when installed. The adjustment plate can be moved relative to the guide plate and the second slot to be aligned with an exact neutral position of the control lever, for any given power machine (e.g., with various stack-ups of manufacturing tolerances). Thus, an adjustment plate can effectively reduce the width of the second slot while also ensuring that a control lever can be received within the second slot (and the third slot) only when the control lever is appropriately aligned with the neutral position.

Aspects of the disclosed technology can also provide for improved systems methods for cutting assemblies of a mower, which can reduce damage caused by accidental impacts with heavy or stationary objects during a cutting operation (e.g., stumps, stones, pipes, etc.). For example, a mower can include one or more cutting assemblies operatively mounted to a deck assembly. A cutting assembly can include a motor that can be configured to rotate a cutting blade that is operatively secured to a spindle of the motor (i.e., an output interface of the motor). To account for elevated inertial loads resulting from impacts with stationary objects and prevent damage to the motor itself, an adapter can be provided between the motor spindle and the blade to transmit operational torque from the motor to the blade. In particular, the adapter can be mechanically coupled to rotate with the motor spindle (e.g., using a keyed or other rotationally locked configuration) and can be frictionally coupled with the blade (e.g., based on compressive force parallel to an axis of rotation).

In some examples, an adapter can define a recess configured to receive the motor spindle and a protrusion can extend into the recess to be received in a corresponding slot in the spindle (e.g., to form a keyed connection). The protrusion can be configured to yield destructively at a first torque value, so as to stop transmitting the operational torque from the motor to the blade for torque values larger than the first torque value. Additionally, the adapter can define a friction surface that is configured to engage with the blade to transmit torque from the motor via by frictional contact with the blade. For example, a fastener (e.g., a bolt) can pass through the blade and into a central hole of the spindle to secure the blade to the friction surface, and thereby sandwich the adapter between the spindle and the blade.

In some cases, such a friction surface can be designed with a contact area that corresponds to the torque to be applied to the fastener during installation. Accordingly, the blade can be caused to rotate by frictional contact during normal operation at a first torque value, and to slip non-destructively relative to the adapter at a second torque value so as to stop transmission of torque between the adapter and the blade.

In particular, each of the first and second torque values can be higher than a maximum operational motor torque so that the blade always rotates with the spindle under normal operating conditions and only moves relative to the spindle as a result of an inertial load from an undesired impact (e.g., with a substantially stationary object). Further, the second torque value can be less than the first torque value so that the blade can non-destructively slip without damaging the adapter (e.g., by destructively yielding the protrusion) when the imparted torque is less than the first torque value. Further still, in some cases, each of the first and second torque values can be higher than a third torque corresponding to an over-torque protection limit of the motor. Thus, for imparted torque values above the third torque value and below the first and second torque values, an over-torque protection feature of the motor can prevent the blade from rotating.

In some cases, the adapter can also help reduce ingression of debris (e.g., dust dirt, mud, etc.) into the motor. Specifically, a motor can include a lip seal between a motor housing and the spindle, which can result in a small gap between the spindle and the motor. An adapter can be configured to be fitted over the spindle and an operational end of a motor, forming a non-linear path extending radially inwardly between the adapter and the motor. The path between the adapter and motor can function as a labyrinth seal to help prevent debris entering the motor through the gap.

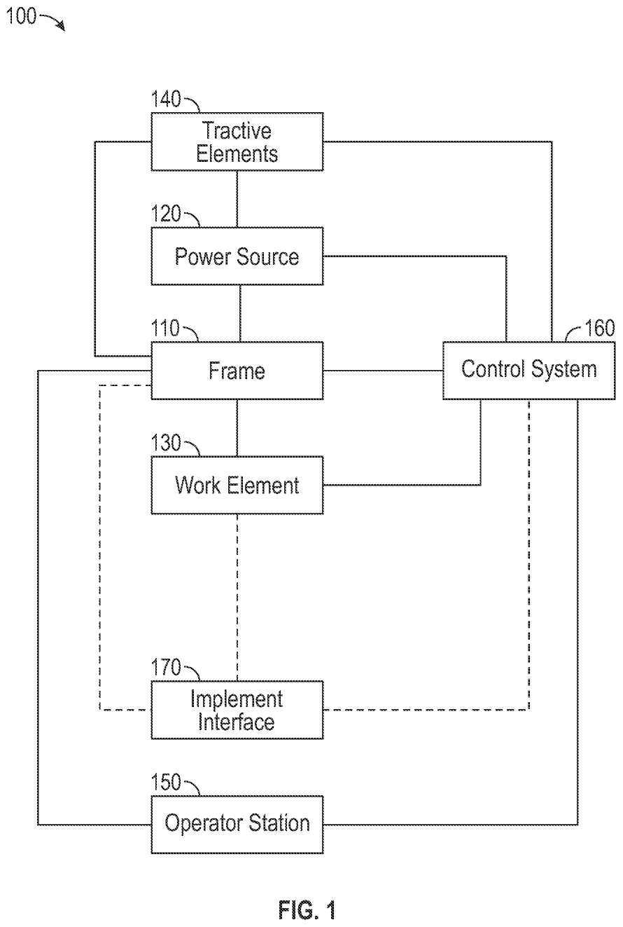

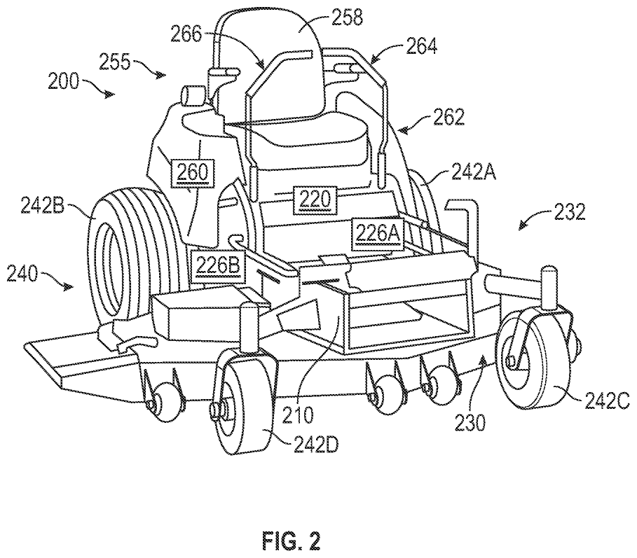

These concepts can be practiced on various power machines, as will be described below. A representative power machine on which the embodiments can be practiced is illustrated in diagram form in FIG. 1 and one example of such a power machine is illustrated in FIG. 2 and described below before any embodiments are disclosed. For the sake of brevity, only one power machine is discussed. However, as mentioned above, the embodiments below can be practiced on any of a number of power machines, including power machines of different types from the representative power machine shown in FIG. 2. Power machines, for the purposes of this discussion, include a frame, at least one work element, and a power source that can provide power to the work element to accomplish a work task. One type of power machine is a self-propelled work vehicle. Self-propelled work vehicles are a class of power machines that include a frame, work element, and a power source that can provide power to the work element. At least one of the work elements is a motive system for moving the power machine under power. In some examples, a power machine can be a self-propelled mower, including a mower with a work element configured as a mower deck with one or more rotating blades, and additional work elements configured as separately controllable right- and left-side drive elements to allow skid-steer operation.

FIG. 1 is a block diagram that illustrates the basic systems of a power machine 100, which can be any of a number of different types of power machines and upon which the embodiments discussed below can be advantageously incorporated. The block diagram of FIG. 1 identifies various systems on power machine 100 and the relationship between various components and systems. As mentioned above, at the most basic lever, power machines for the purposes of this discussion include a frame, a power source, and a work element. The power machine 100 has a frame 110, a power source 120, and a work element 130. Because power machine 100 shown in FIG. 1 is a self-propelled work vehicle, it also has tractive elements 140, which are themselves work elements provided to move the power machine over a support surface and an operator station 150 that provides an operating position for controlling the work elements of the power machine. A control system 160 is provided to interact with the other systems to perform various work tasks at least in part in response to control signals provided by an operator. For example, the control system 160 can be an integrated or distributed architecture of one or more processor devices and one or more memories that are collectively configured to receive operator input or other input signals (e.g., sensor data) and to output commands accordingly for power machine operations

Certain work vehicles have work elements that can perform a dedicated task. For example, some work vehicles have a mower deck that can be attached to a main frame of the work vehicles in various ways (e.g., as an implement attached to a lift arm). Cutting elements of the mower deck can then be controlled (e.g., to control speed of one or more rotating blades) or the mower deck can be otherwise manipulated (e.g., moved relative to the main frame of the power machine) to perform mowing or other tasks.

Some work vehicles may be able to accept other implements by disassembling a current implement/work element combination and reassembling with another implement in place of the original. Generally, work vehicles are intended to be used with a wide variety of implements and can have an implement interface such as implement interface 170 shown in FIG. 1. At its most basic, implement interface 170 is a connection mechanism between the frame 110 or a work element 130 and an implement, which can be as simple as a connection point for attaching an implement directly to the frame 110 or a work element 130, or may include more complex mechanisms or structures. In some embodiments, the implement interface can be a pinned connection that secures a mower deck to a movable support structure so that the support structure can be moved relative to a main frame of the power machine to adjust a height (or other orientation) of the mower deck.

Frame 110 includes a physical structure that can support various other components that are attached thereto or positioned thereon. The frame 110 can include any number of individual components. Some power machines have frames that are rigid. That is, no part of the frame is movable with respect to another part of the frame. Other power machines have at least one portion that can move with respect to another portion of the frame. For example, excavators can have an upper frame portion that rotates with respect to a lower frame portion. Other work vehicles have articulated frames such that one portion of the frame pivots with respect to another portion for accomplishing steering functions.

Frame 110 supports the power source 120, which can provide power to one or more work elements 130 including the one or more tractive elements 140, as well as, in some instances, providing power for use by an attached implement via implement interface 170. Power from the power source 120 can be provided directly to any of the work elements 130, tractive elements 140, and implement interfaces 170. Alternatively, power from the power source 120 can be provided to a control system 160 (e.g., a system of electronic, hydraulic, electro-hydraulic, or other control devices), which in turn selectively provides power to the elements that are capable of using the power to perform a work function. Power sources for power machines typically include an engine such as an internal combustion engine and a power conversion system such as a mechanical transmission or a hydraulic system that can convert the output from an engine into a form of power that is usable by a work element. Other types of power sources can be incorporated into power machines, including electrical sources or a combination of power sources, known generally as hybrid power sources.

FIG. 1 shows a single work element designated as a work element 130, but various power machines can have any number of work elements. Work elements are typically attached to the frame of the power machine and movable with respect to the frame when performing a work task. In some embodiments, as also discussed above, work elements can include mower decks or other similar equipment. In some embodiments, work elements can include lift arm assemblies or other similar systems. In addition, tractive elements 140 are a special case of work element in that their work function is generally to move the power machine 100 over a support surface. Tractive elements 140 are shown separate from the work element 130 because many power machines have additional work elements besides tractive elements, although that is not always the case. Power machines can have any number of tractive elements, some or all of which can receive power from the power source 120 to propel the power machine 100. Tractive elements can be, for example, wheels attached to an axle, track assemblies, and the like. Tractive elements can be mounted to the frame such that movement of the tractive element is limited to rotation about an axle (so that steering is accomplished by a skidding action) or, alternatively, pivotally mounted to the frame to accomplish steering by pivoting the tractive element with respect to the frame.

Power machine 100 includes an operator station 150 that includes an operating position from which an operator can control operation of the power machine. In some power machines, the operator station 150 is defined by an enclosed or partially enclosed cab. Some power machines on which the disclosed embodiments may be practiced may not have a cab or an operator compartment of the type described above. For example, a walk behind loader may not have a cab or an operator compartment, but rather an operating position that serves as an operator station from which the power machine is properly operated. More broadly, power machines other than work vehicles may have operator stations that are not necessarily similar to the operating positions and operator compartments referenced above. Further, some power machines such as power machine 100 and others, whether they have operator compartments, operator positions or neither, may be capable of being operated remotely (i.e., from a remotely located operator station) instead of or in addition to an operator station adjacent or on the power machine. This can include applications where at least some of the operator-controlled functions of the power machine can be operated from an operating position associated with an implement that is coupled to the power machine. Alternatively, with some power machines, a remote-control device can be provided (i.e., remote from both the power machine and any implement to which is it coupled) that is capable of controlling at least some of the operator-controlled functions on the power machine.

FIG. 2 illustrates a mower 200, which is one particular example of a power machine of the type illustrated in FIG. 1 where the embodiments discussed below can be advantageously employed. Mower 200 is one particular example of the power machine 100 illustrated broadly in FIG. 1 and discussed above. To that end, features of mower 200 described below include reference numbers that are generally similar to those used in FIG. 1. For example, mower 200 is described as having a frame 210, just as power machine 100 has a frame 110.

Mower 200 is shown as a zero-turn riding lawn mower, but it could also be a differently configured riding lawn mower, or a walk-behind or pull-type lawn mower. Correspondingly, the description herein of mower 200 with references to FIG. 2 provides an illustration of the environment in which the embodiments discussed below can be practiced, and this description should not be considered limiting especially as to the description of features of the mower 200 that are not essential to the disclosed embodiments. Such features may or may not be included in power machines other than mower 200 upon which the embodiments disclosed below may be advantageously practiced. Unless specifically noted otherwise, embodiments disclosed below can be practiced on a variety of power machines, with the mower 200 being only one of those power machines. For example, some or all of the concepts discussed below can be practiced on many other types of work vehicles such as various other mowers, as well as loaders, excavators, trenchers, and dozers, to name but a few examples.

Mower 200 includes frame 210 that supports a power system 220 that can generate or otherwise provide power for operating various functions on the power machine. Frame 210 also supports a work element in the form of mower deck 230 that is powered by the power system 220 and that can perform various work tasks (e.g., cutting at different blade speeds or deck heights). As mower 200 is a work vehicle, the frame 210 also supports a tractive system 240, which is also powered by power system 220 and can propel the power machine over a support surface. In particular, in the illustrated example, the tractive system 240 includes powered wheels 242A, 242B, as well as un-powered casters 242C, 242D, as further discussed below.

A deck support assembly 232 supports the deck 230 relative to the frame 210 and can be configured for selective adjustment to provide different cutting heights, angles, etc. for the deck 230, as well as for selective removal of the deck 230 or installation of additional or alternative work elements (e.g., other mower decks, ducts, and other material handling devices for cut plant material, etc.). The deck 230 can include one or more rotatable blades (not shown), which can be controlled (e.g., collectively or individually) to cut grass or other material, and which can be powered by hydraulic, electronic, or mechanical connections to the power system 220.

As a riding lawn mower, the mower 200 includes an operator station 255 supported on the frame 210, from which an operator can manipulate various control devices to cause the mower 200 to perform various work functions. In the illustrated example, in particular, the operator station 250 includes an operator seat 258, as well as the various operation input devices 262 in communication with a control system 260 (e.g., a hydraulic control system, or an electronic control system including an electronic hub controller and other distributed controllers that are electronically in communication with the hub controller). The input devices 262 generally allow an operator to control tractive and workgroup operations, so that the mower 200 can be directed to move over terrain and selectively cut grass or other plants along the terrain (or otherwise executed desired work operations).

In some case, the input devices 262 can allow for skid-steer tractive control of the mower 200. For example, the input devices 262 can include left- and right-side control levers 264, 266 that can be independently moved by an operator to direct, respectively, rotation of left- and right-side drive motors 226A, 226B for independent commanded rotation of left- and right-side tractive elements (e.g., the drive wheels 242A, 242B, as shown). In some cases, the levers 264, 266 can directly control delivery of hydraulic or other power. In some cases, the levers 264, 266 can indirectly control power delivery, including by adjusting a pilot flow for a powered hydraulic system of the mower 200 or by providing electronic signals that direct control of hydraulic, electronic, or other power delivery systems by way of one or more intervening hydraulic or electronic controllers included in the control system 260. Further, other configurations are possible for operator input devices, including configurations with different types of control levers that an operator can manipulate to control various machine functions. In some configurations, the operator input devices 262 can include a joystick (e.g., only a single joystick for tractive operations), a steering wheel, buttons, switches, levers, sliders, pedals, and the like, which can be stand-alone devices such as hand operated levers or foot pedals, or can incorporated into hand grips or display panels, and can sometimes include programmable input devices.

As generally noted above, actuation of operator input devices can generate signals in the form of electrical signals, hydraulic signals, or mechanical signals. Signals generated in response to operator input devices are provided to various components on the power machine for controlling various functions on the power machine. Among the functions that are controlled via operator input devices on power machine 200 are operational functions of the tractive system 240, the mower deck 230, other implements (not shown) including various other attachments (not shown).

In some cases, the control system 260 can be configured to operate without input from operator input devices 262 for one or more operations. For example, the control system 260 can be configured for automatic control of certain operations of the mower 200 or can include wireless communication capabilities so as to receive control commands or other relevant data from remotely located (i.e., not mechanically tethered) and other systems.

Mowers can sometimes include other human-machine interfaces, including display devices that are provided in the operator station 255 to give indications of information relatable to the operation of the power machines in a form that can be sensed by an operator, such as, for example, audible and/or visual indications. Audible indications can be made in the form of buzzers, bells, and the like or via verbal communication. Visual indications can be made in the form of graphs, lights, icons, gauges, alphanumeric characters, and the like. Displays can be dedicated to providing dedicated indications, such as warning lights or gauges, or dynamic to provide programmable information, including programmable display devices such as monitors of various sizes and capabilities. Display devices can provide diagnostic information, troubleshooting information, instructional information, and various other types of information that assists an operator with operation of the power machine or an implement coupled to the power machine. Other information that may be useful for an operator can also be provided. Other power machines, such as walk behind mowers for example, may not have a cab nor an operator compartment, nor a seat. The operator position on such mowers is generally defined relative to a position where an operator is best suited to manipulate operator input devices.

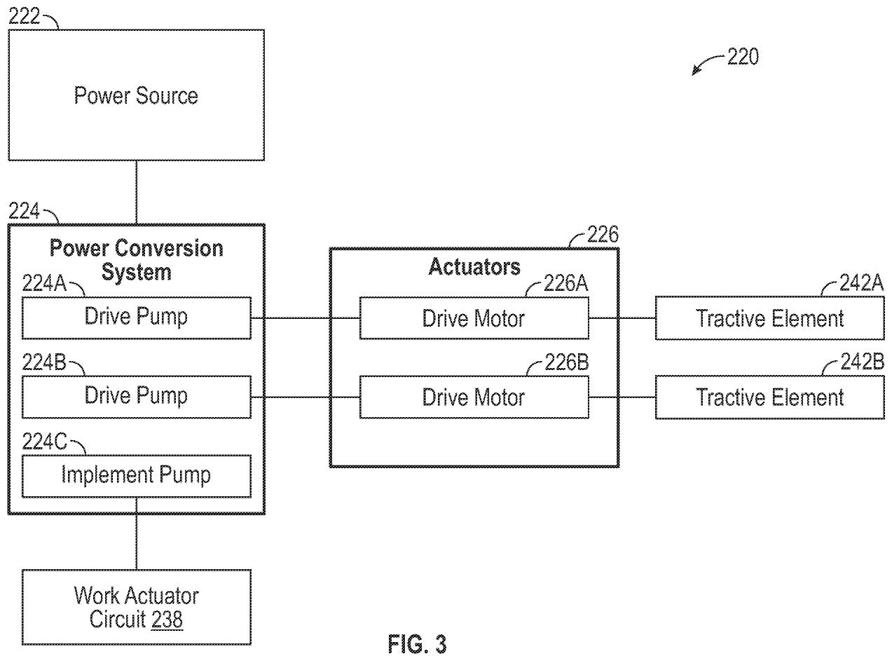

FIG. 3 illustrates an example of power system 220 in more detail for a hydraulically powered system. Broadly speaking, power system 220 includes one or more power sources 222 that can generate and/or store power for operating various machine functions. On mower 200, the power system 220 includes an internal combustion engine. Other power machines can include electric generators, rechargeable or replaceable batteries, various other power sources or any combination of power sources that can provide power for given power machine components. The power system 220 also includes a power conversion system 224, which is operably coupled to the power source 222. Power conversion system 224 is, in turn, coupled to one or more actuators 226, which can perform a function on the power machine. Power conversion systems in various power machines can include various components, including mechanical transmissions, hydraulic systems, systems for transmitting and utilizing electrical power, and the like.

In a hydraulically powered example, the power conversion system 224 of power machine 200 can include hydrostatic drive pumps 224A, 224B, which provide a power signal to drive motors 226A, 226B, respectively. The drive motors 226A, 226B in turn are each operably coupled to a respective tractive element 242A, 242B (e.g., the wheels 242A, 242B as shown in FIG. 2). The hydrostatic drive pumps 224A, 224B can be mechanically, hydraulically, or electrically coupled to operator input devices (or otherwise in communication with the control system 260) to receive actuation signals for controlling the drive pump. The power conversion system also includes an implement pump 224C, which can be driven by the power source 222 to provide pressurized hydraulic fluid to a work actuator circuit 238 for operation of a work actuator (e.g., one or more motors for rotation of the blades of the deck 230). The work actuator circuit 238 can include valves and other devices to selectively provide pressurized hydraulic fluid to the various relevant work actuators. In addition, the work actuator circuit 238 can be configured to provide pressurized hydraulic fluid to work actuators on an attached implement.

As also noted above, in some cases, actuators of a power machine can be electrically powered. Correspondingly, in some cases, the power conversion system 224 may include electronic or other devices configured for transmission of current to, and general control of, one or more electric motors included in the actuators 226 (e.g., left- and right-side drive motors) and one or more electric motors of non-tractive work elements (e.g., electronic motors of the actuators 226, as included on the deck 230 to power rotation of cutting blades).

The description of power machine 100 and mower 200 above is provided for illustrative purposes, to provide illustrative environments on which the embodiments discussed below can be practiced. While the embodiments discussed can be practiced on a power machine such as is generally described by the power machine 100 shown in the block diagram of FIG. 1 and more particularly on a mower such as zero-turn mower 200, unless otherwise noted or recited, the concepts discussed below are not intended to be limited in their application to the environments specifically described above.

As briefly mentioned above, in some embodiments, a power machine can be configured as an electrically powered power machine (e.g., a hybrid or fully-electric power machine), in which one or more functions of the power machine can be performed using electrical power. For example, in some cases, a power machine (e.g., the mower 200) can be configured as an electrically powered mower that includes a power source configured as a battery (e.g., a rechargeable, high-voltage battery with a voltage ranging between approximately 42 volts and approximately 58 volts). To distribute power to and from a battery (e.g., for charging and discharging), a power machine can include various power electronics that can be configured to control a flow of electrical current through the power machine, including to separately, controllably provide tractive and cutting power.

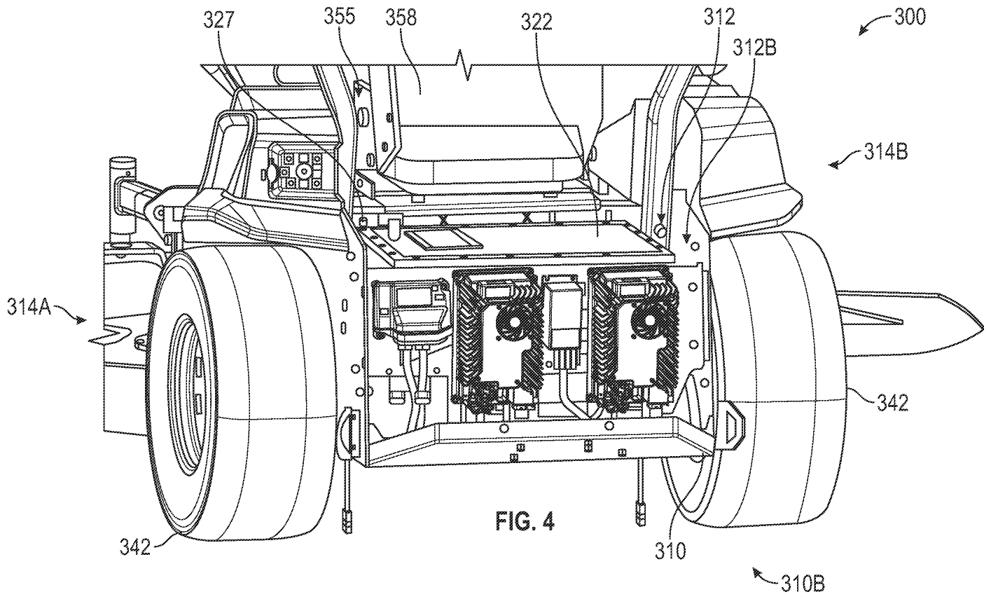

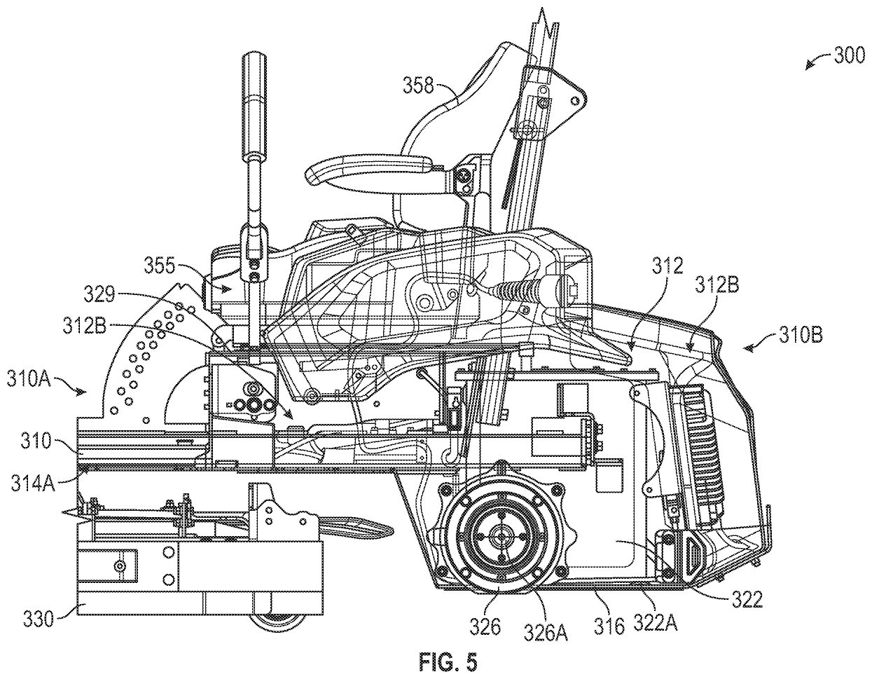

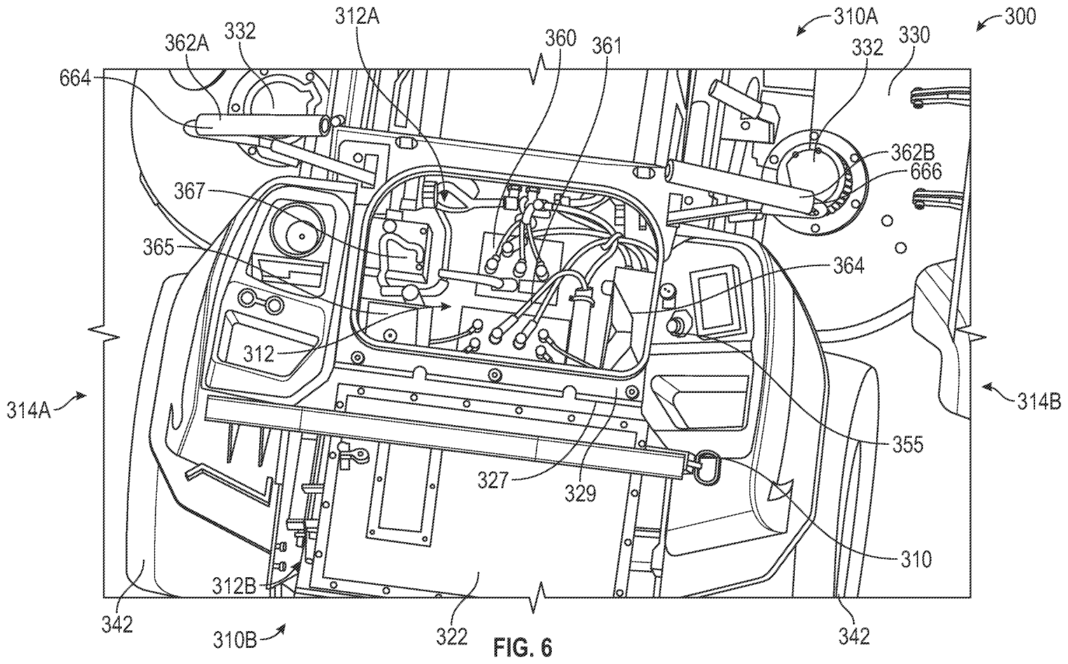

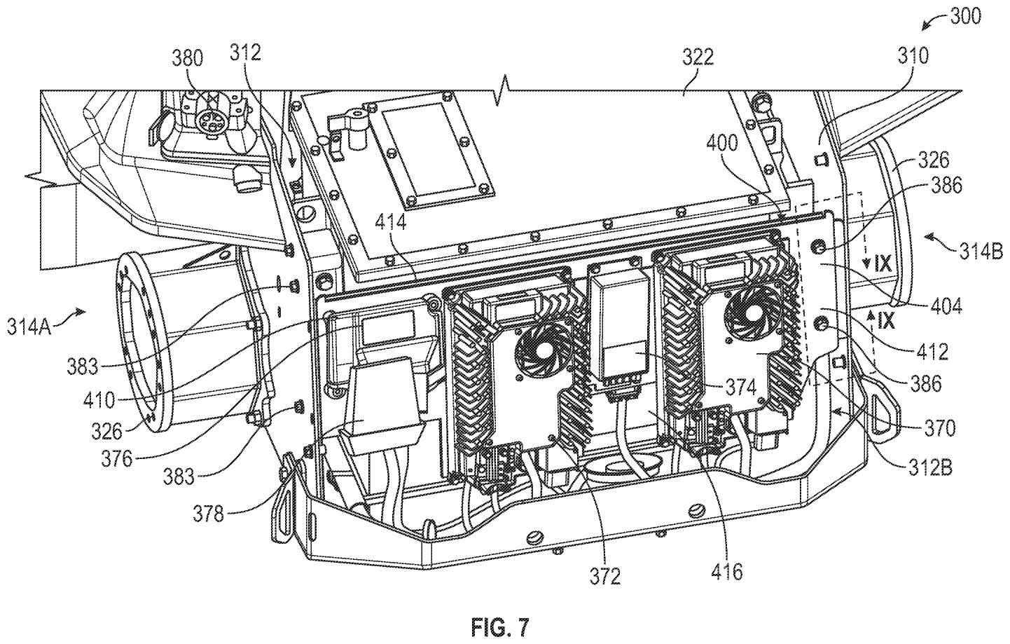

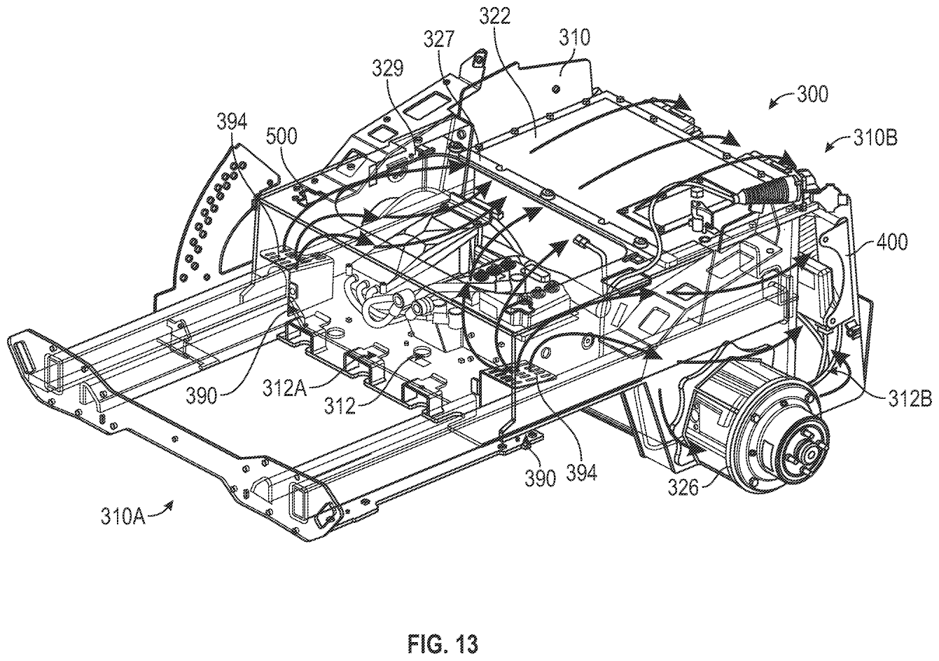

For example, FIGS. 4 and 5 provide partial views of an example power machine configured as a mower 300. The mower 300 is an electrically powered mower with a power source configured as a battery 322 (e.g., a multi-cell lithium-ion battery assembly) that provides electrical power to perform one or more work or tractive functions of the mower 300. Similar to the mower 200, the mower 300 includes a frame 310 having a front end 310A (see FIG. 5) opposite a rear end 310B, although other mowers may exhibit other frame geometry. As shown, the frame 310 is configured to support an operator station 355 with an operator seat 358, from which an operator can manipulate an input device of the mower 300, although other examples can include otherwise configured operator stations (e.g., standing operator stations or no operation stations). In the illustrated example, an operator can manipulate each of a left and a right control assembly 362A, 362B (e.g., first and second control assemblies, see FIG. 6) to control a respective left or right traction motor 326 (see FIG. 7), which can be configured to operate a respective wheel 342 to propel the mower 300 along a support surface. The traction motors 326 are at least partially disposed within an internal cavity 312 of the frame 310 (see FIGS. 5 and 13) and extend through respective left and right sides 314A, 314B of the frame 310 to operatively couple with the wheels 242.

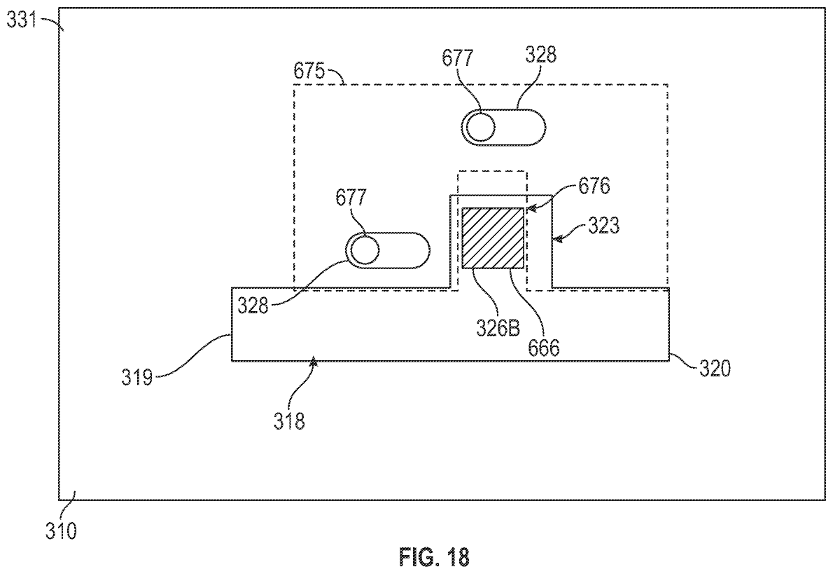

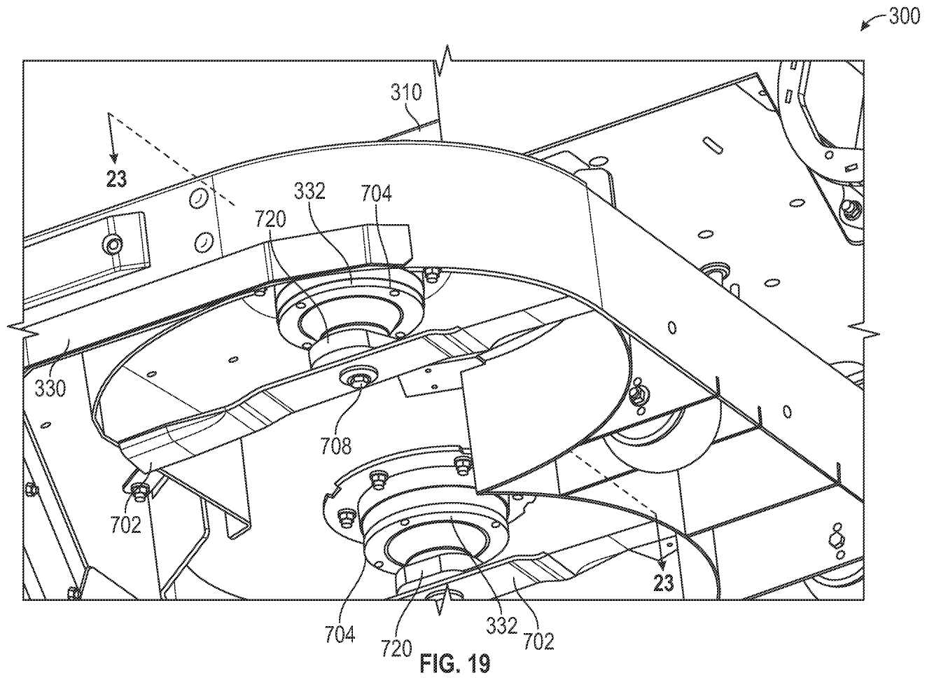

The frame 310 can be configured to operatively support a mower deck 330 with a plurality of cutting assemblies 332 (see FIGS. 6 and 18), which can be individually or collectively operated to rotate blades to perform cutting operations with the mower. In the illustrated embodiment, the mower deck 330 includes three cutting assemblies 332, namely, a left, a right, and a central cutting assembly (see FIG. 6 showing left and right cutting assemblies, and FIG. 19 showing left and central cutting assemblies). In other embodiments, more or fewer cutting assemblies can be provided or can be differently located on a power machine frame.

In some embodiments, a frame can also be configured to support a battery within an internal cavity of the frame, including so as to reduce a center of gravity of a mower as compared to conventional designs. For example, still referring to FIGS. 4 and 5, the frame 310 the battery 322 is disposed within the internal cavity 312 so that a bottom surface 322A of the battery 322 is supported by a bottom support surface 316 of the frame 310. Accordingly, as is best shown in FIG. 5, the bottom surface 322A of the battery 322 is positioned vertically below a central axis 326A of the traction motors 326. In other embodiments, the battery 322 may be indirectly supported by the bottom support surface 316 of the frame 310. For example, spacers or vibration dampeners of generally known configurations (not shown) can be positioned between the battery 322 and the bottom support surface 316 of the frame 310.

In some examples, within the internal cavity 312, the battery 322 can be positioned laterally between the traction motors 326 so that the battery 322 is laterally inboard of each traction motor 326. Correspondingly, the battery 322 can be spaced from each of the lateral left and right sides 314A, 314B of the frame 310.

Further, the battery 322 can disposed vertically below the operator station 355 (e.g., the seat 358). Accordingly, the battery 322 can also be spaced below a lateral cross beam 327 and an upper plate 329 of the frame 310, which are aligned vertically below and provide support to the operator station 355. As a result, the battery 322 can also be spaced from each of the lateral cross beam 327 and the upper plate 329 of the frame 310 to define a gap therebetween. As will be described in greater detail below, spacing the battery 322 from the sides 314A, 314B, cross beam 327, and upper plate 329 can provide openings around the battery 322 to allow for a cooling airflow to flow more effectively through the internal cavity 312 and thereby provide improved cooling as compared to conventional designs.

In some embodiments, a battery can subdivide an internal cavity into different bays for securing various components of a mower (i.e., can subdivide a cavity so that flow from one bay of the cavity to another must be routed around the battery). For example, with additional reference to FIGS. 6 and 7, the battery 322 can divide the internal cavity into a first bay 312A and a second bay 312B. Accordingly, in the example shown, the battery 322 can be positioned at least partially within each of the first bay 312A and the second bay 312B. As illustrated, the first bay 312A is a front bay that is aligned generally forward of the battery 322 and vertically below the operator station 355, and the second bay 312B is a rear bay that is positioned substantially rearward of the operator station 355. The second bay 312B can be located (e.g., but not aligned) vertically below the operator station 355.

A bay of an internal cavity can be configured to hold power electronic components of a mower, thereby protecting the power electronics from the surrounding environment and allowing for improved cooling from internal air flow. In the illustrated embodiment, each of the first bay 312A and the second bay 312B are configured to hold power electronics for operation of the mower 300. More specifically, as shown in FIG. 6, the first bay 312A can be a first power electronics bay configured to hold first power electronics. For example, as illustrated, first power electronics can include one or more of a cutting assembly inverter 360 for supplying electrical current to the cutting assemblies 332 (e.g., to a motor of each cutting assembly 332), a traction motor inverter 361 for supplying electrical current to the traction motors 326, a power distribution unit 364 for controlling a flow of electrical current through the mower 300, a fuse box 365, or an auxiliary battery 367 (e.g., a low-voltage battery with a voltage of approximately 12 volts). The first power electronics are shown positioned generally forward of the battery 322, but can be arranged differently relative to the battery 322 and one another in other embodiments. Generally, a plurality of the power electronics noted above can be included in a forward bay (e.g., as shown for the first bay 312A) or other bay toward an upstream end of a cooling flow path, although some power electronics can be differently located in some examples.

As shown in FIG. 7, the second bay 312B can be a second power electronics bay configured to hold second power electronics. Specifically, in the illustrated embodiment, the second power electronics can include charging system components, including one or more of a first charger 370, a second charger 372, a DC/DC converter 374, a hub controller 376 for controlling one or more functions of the mower 300 (e.g., to operate a cutting assembly), or a communication module 378. Correspondingly, electrical current for charging can be supplied from the external charging unit to the mower 300 via a charging port 380, as regulated and controlled by the components noted above. As illustrated, the charging port 380 is configured as a SAE J1772 charging port. However other types of charging connection can also be used. Generally, a plurality of the power electronics for charging as noted above can be included in a rearward bay, although some power electronics can be differently located in some examples.

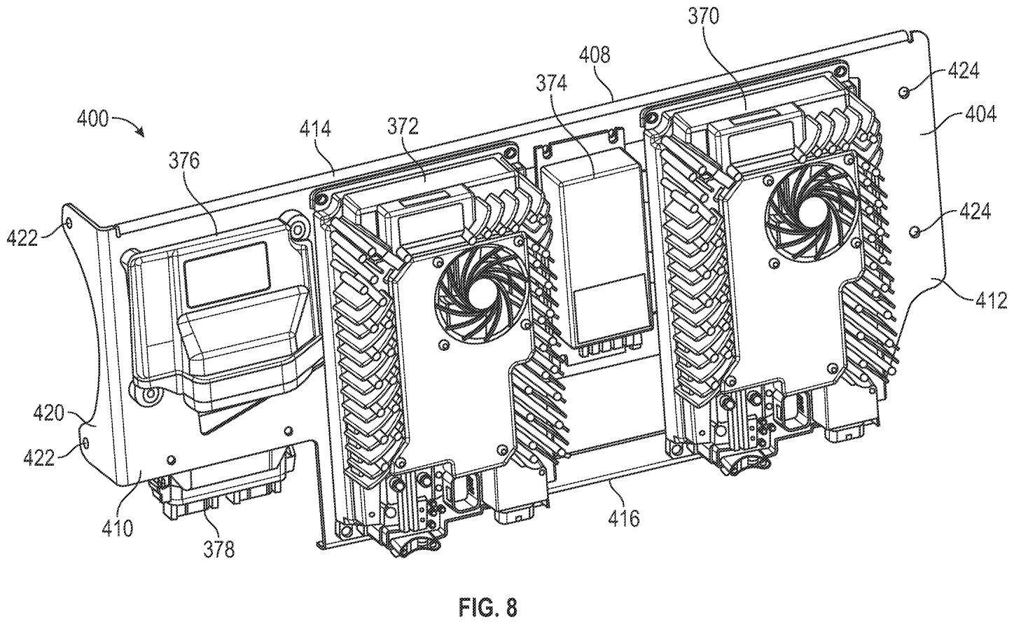

In some embodiments, charging system components or other second power electronics can be provided as a pre-assembled sub-assembly that can be installed onto a mower as a single unit. For example, as illustrated in FIGS. 7 and 8, some of all of the second power electronics for a power machine can be included in a charging sub-assembly 400 that can be installed into the second bay 312B as a single unit. Correspondingly, to ease installation, the charging sub-assembly 400 can be positioned generally rearward of the battery 322 within the second bay 312B in some examples.

An electronics sub-assembly can generally include a main support structure that is configured to support one or more power electronics within a bay of a mower. For example, the charging sub-assembly 400 can include a plate 404 (i.e., a support plate) that is configured to support the second power electronics within the second bay 312B. The plate 404 is configured as a substantially planar, elongated (e.g., rectangular) plate having a first side 406 opposite a second side 408. Additionally, the plate 404 defines a first end 410 opposite a second end 412, and an upper edge 414 and a lower edge 416 that extend between the first end 410 and the second end 412.

As illustrated in FIG. 7, the plate 404 can be transversely mounted in the second bay 312B to extend between opposing lateral sides of the second bay 312B (e.g., to extend between the left and right sides 314A, 314B of the frame 310). In some embodiments, particular mounting structures can be used to provide improved adaptability during installation (e.g., due to varied stack-up of manufacturing tolerances). Specifically, the plate 404 can include a mounting flange 420 that can extend substantially perpendicularly away from the second side 408 at the first end 410. The mounting flange 420 can include holes 422 that are configured to align with corresponding holes (not shown) in the left side 314A the frame 310. Fasteners 383 can be inserted through the holes to secure the charging sub-assembly 400 to the left side 314A of the frame 310.

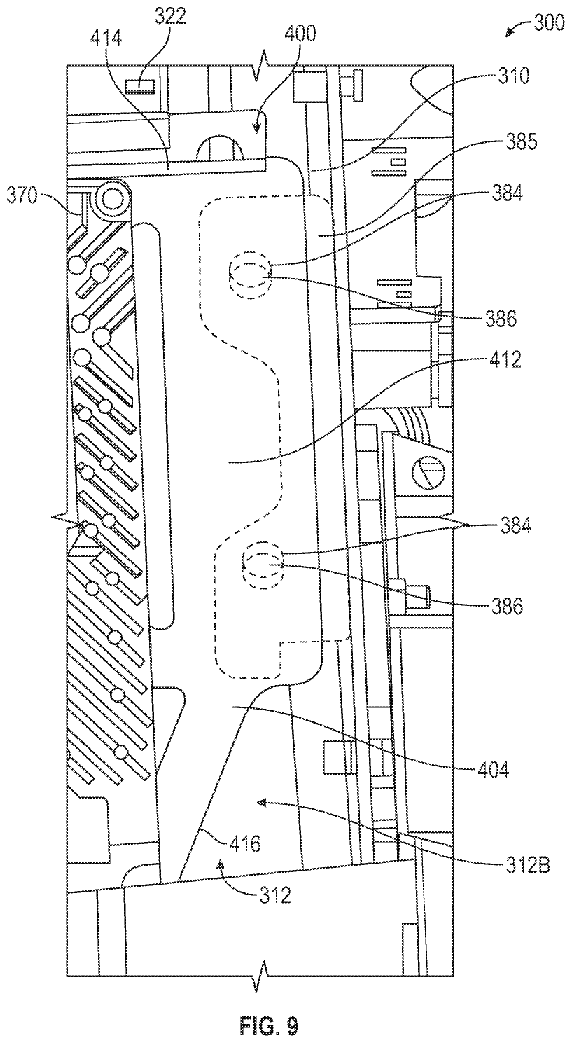

Further, as illustrated in FIG. 9, the plate 404 can define holes 424 at the second end 412 that are configured to align with slots 384 formed in a mounting bracket 385 (i.e., an angled mounting flange, as shown) that extends into the second bay 312B from the right side 314B of the frame 310. Fasteners 386 can be inserted through the holes 424 and the slots 384 to secure the charging sub-assembly 400 to the right side 314B of the frame 310. The slots 384 can permit movement of the plate 404 laterally relative to the frame 310, even while the mounting flange 420 is rigidly secured, for example, to generally ease installation by accommodating variations in frame width due to manufacturing tolerances.

The charging sub-assembly 400 can also be mounted substantially vertically within the second bay 312B so that the first side 406 faces rearward (e.g., away from the battery 322 and toward the rear end 310B of the frame 310) and so that the second side 408 faces forward (e.g., toward the battery 322 and the front end 310A of the frame 310). In some cases, the charging sub-assembly 400 can be angled relative to a vertical direction. For example, as illustrated in FIG. 5, the charging sub-assembly 400 (i.e., the plate 404) is angled at approximately 5 degrees relative to a vertical direction so that the upper edge is 414 is forward of the lower edge 416 (e.g., to be positioned closer to the front end 310A of the frame 310). Correspondingly, the mounting bracket 385 can also be similarly angled. As will be described in greater detail below, an angled orientation of the plate 404 can improve air flow within the second bay 312B to improve cooling of the second power electronics.

As also generally discussed above, second power electronics can be positioned on a plate of a sub-assembly to facilitate improved cooling and improved access to certain power electronic components when installed in a mower (e.g., access for maintenance). For example, as illustrated in FIGS. 7 and 8, the hub controller 376, the chargers 370, 372, and the DC/DC converter 374 can be coupled to the first side 406 of the plate 404, while the communication module 378 can be coupled to the second side 408 of the plate 404. More specifically, the hub controller 376 can be coupled at the first end 410 of the plate 404 and the second charger 372 can be coupled to the second end 412 of the plate 404. The first charger 370 can be coupled to the plate 404 between the hub controller 376 and the second charger 372 and the DC/DC converter 374 can be coupled to the plate 404 between the chargers 370, 372 (e.g., so that the first charger 370 is closer to the first end 410 than is the DC/DC converter 374). As discussed in greater detail below, positioning the DC/DC converter 374 between the chargers 370, 372 can provide a channel for a cooling airflow between the chargers 370, 372 and so that warm air from one charger isn't blown directly onto the other charger. Further, the communication module 378 can be coupled at the first end 410 of the plate 404, substantially opposite the hub controller 376. In other embodiments, power electronics can be arranged differently on a plate of a sub-assembly, including in arrangements in which no power electronics are included on a forward side of a sub-assembly.

In some embodiments, a mower can further include a fan assembly and associated structures to define and maintain a cooling airflow to help maintain power electronics below one or more threshold temperatures (e.g., maximum rated operating temperatures). For example, during a charging process chargers can quickly increase in temperature. Accordingly, in some cases a fan assembly can be operated to provide a cooling airflow that can extract heat from a charger to maintain the charger below a maximum threshold temperature, thereby improving charging efficiency and speed.

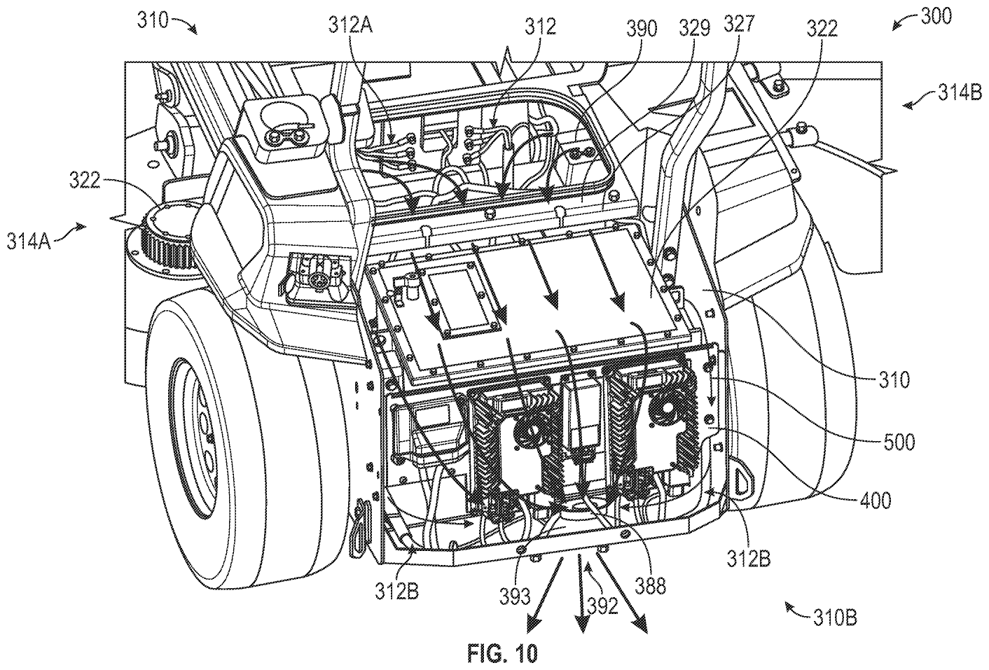

For example, as illustrated in FIGS. 10-14 , the mower 300 can include a fan 388 that can be configured to provide a cooling airflow to extract heat from the various power electronics, in particular, the chargers 370, 372, and reject the heat to the ambient environment. To that end, the hub controller 376 can be configured to operate the fan 388 when a charging sequence begins (e.g., when the communication module 378 establishes a communication link with an external charger or when an external charger begins to supply electrical current to the chargers 370, 372). In other embodiments, the hub controller 376 can be configured to operate the fan 388 when one or both of the chargers 370, 372 or another charging component (e.g., the DC/DC converter 374) reaches a threshold temperature. Accordingly, the cooling airflow provided by the fan 388 can maintain the chargers below a maximum operating temperature (e.g., approximately 400 C).

In some embodiments, a controller (e.g., a hub controller) can also operate a fan assembly during a work operation of a mower to control temperature of other power electronics. For example, during a cutting or traveling operation, the hub controller 376 can be configured to operate the fan 388 to provide cooling airflow when a temperature of one of the traction motors 326, or of one of the first power electronics in the first bay 312A, reaches a threshold temperature (e.g., approximately 100 C). The cooling airflow can thus pass over the various components to be cooled during operation of the power machine to extract heat and reject it to the surrounding environment.

In general, operation of a fan can create a cooling airflow that enters an interior cavity of a mower via one or more air inlets, travels through the interior cavity past components requiring cooling, and then exits the interior cavity through an air outlet. A fan to power the airflow can be provided at the air inlet, or more preferably, the air outlet. Correspondingly, in the illustrated embodiment, a cooling airflow 500 is drawn into the internal cavity 312 via air inlets 390 provided at a front portion of the internal cavity 312, then travels rearward (i.e., downstream) through the internal cavity 312 to exit via an air outlet 392. The fan 388 is positioned over the air outlet 392, and a fan guide structure 393 can extend between the fan 388 and the air outlet 392 to help guide the airflow 500 out of the internal cavity 312.

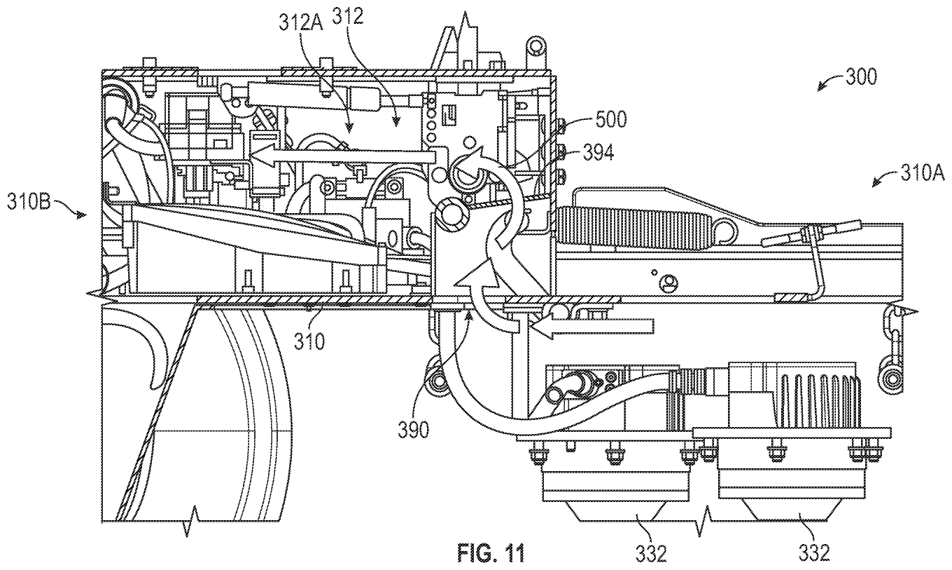

More specifically, with continued reference to FIGS. 10-14, a cooling airflow 500 can enter the internal cavity 312 of the mower 300 via air inlets 390 that are provided in a bottom and front portion of the first bay 312A (i.e., a bottom of the frame 310), with one air inlet provided at each of the left and right sides 314A, 314B . With particular reference to FIG. 11 (showing only the right air inlet 390), ambient air can enter through the air inlets 390, traveling upwardly into the first bay 312A where the airflow 500 then turns to travel generally rearward to the second bay 312B. A grate 394 or other filtering structure can be provided over each air inlet 390 to prevent debris (e.g., grass clippings, leaves, etc.) from entering the first bay 312A. Further, while the upward direction of the airflow 500 can help to mitigate the chance of debris passing into the air inlet 390, the downwardly oriented opening of the air inlet 390 can also allow any debris that is caught by the grate 394 to easily fall back out of the air inlet 390, thereby maintaining a clear path of airflow.

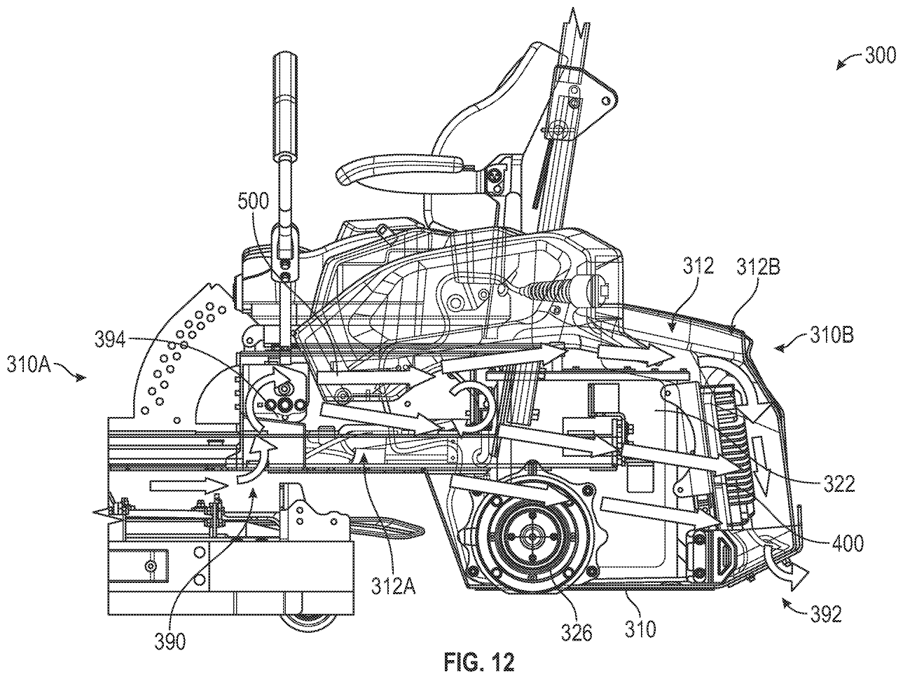

As best shown in FIGS. 10, 12, and 13, having passed into the first bay 312A from the air inlets 390, the cooling airflow 500 can then pass through the first bay 312A and generally toward the second bay 312B. During flow through the first bay 312A, the airflow 500 can pass over and extract heat from the first power electronics. Further, as shown in FIG. 12, turbulent eddies and other larger-scale flow patterns can result in some of the airflow 500 circulating within the first bay 312A, further increasing heat transfer from the first power electronics to the airflow 500. This circulation, in some cases, can be further enhanced by the downstream flow restriction provided the location of the battery 322 between the first and second bays 312A, 312B (see also discussion below).

From the first bay 312A, the cooling airflow 500 can then take one or more flow paths around the battery 322 to pass into the second bay 312B. For example, a bulk of the airflow 500 in some examples can pass above the battery 322 (e.g., through the gap between the battery 322 and both the lateral cross beam 327 and the upper plate 329 of the frame 310). The portion of the airflow 500 passing over the top of the battery 322 can then turn downward to flow toward the fan 388 and out of the air outlet 392. Thus, the airflow 500 can pass over and extract heat from the second power electronics (e.g., over both sides of the charging subassembly 400, as facilitated by the mounting configuration discussed above). In particular, the airflow 500 air can flow in a substantially vertical airflow channel 502 between the chargers 370, 372 to flow over the DC/DC converter 374. In this regard, the lateral spacing of the chargers 370, 372 to provide the cooling channel 502—for cooling of the converter 374 or other components—can result in a further notable benefit of the illustrated sub-assembly design.

Correspondingly, to help guide the airflow 500 downward and past the charging subassembly 400, and then reject the heat received from all of the relevant upstream components, the air outlet 392 can be provided in the bottom support surface 316 of the frame 310. Or, more generally, the fan 388 can be oriented to provide a downward outlet flow or downward flow generally through the second bay 312B. As a result, the airflow 500 can be rejected from the mower 300 in downward direction.

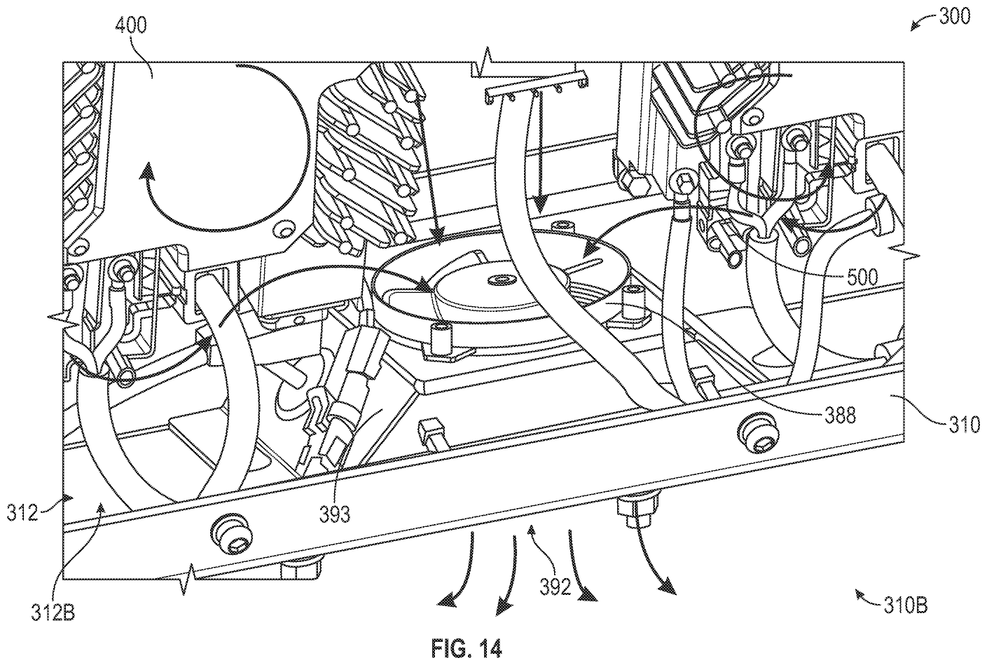

As shown in FIGS. 12 and 13, in addition to flowing over the top of the battery 322, portions of the airflow 500 can also pass along the lateral sides of the battery 322 (e.g., between and the battery 322 and each of the left and right sides 314A, 314B of the frame 310). As best shown in FIG. 13, due to the illustrated motor and airflow arrangements, air flowing along the sides of the battery 322 can flow around and cool each of the respective traction motors 326. Having passed the battery 322, the airflow 500 can then curve generally inward and downward to the fan 388 and air outlet 392 to be rejected from the mower 300. Relatedly, the differently angled airflows entering the second bay 312B (e.g., flows from the top and sides of the battery 322) can also contribute to circulation of the airflow within the second bay 312B (see FIG. 14), further improving heat transfer from the second power electronics to the airflow 500.

In some cases, the relative sizes of the flow areas within an internal cavity can improve cooling of any power electronics therein. For example, the first bay 312A defines a first locally enlarged flow area, the second bay 312B defines second locally enlarged flow area, and battery 322 acts as a flow restriction (i.e., a cooling restriction) between the first bay 312A and the second bay 312B (i.e., downstream of the first bay 312A and upstream of the second bay 312B). The flow restriction has a comparatively smaller flow area defined by the gaps between the battery 322 and the frame 310 (i.e., along the top and lateral sides of the battery 322), as compared with the area of the first and second bays 312A, 312B (e.g., with a reduction of cross-sectional flow area of 25%, 50%, 75%, or more). Correspondingly, in accordance with the Bernoulli principle, airflow within the first bay 312A and the second bay 312B can have a slower average (e.g., bulk) speed than the airflow through the restricted flow area defined by the battery 322. As a result, the increased average (e.g., bulk) air speed past the battery 322 can increase heat transfer from the battery 322 and the traction motors 326 as compared to conventional designs. Similarly, enhanced cooling effects can also occur locally to (e.g., between) power electronics, for example, along the airflow channel 502 between the chargers 370, 372. Moreover, the restriction provided by the battery 322 in the illustrated example can further enhance flow patterns in the airflow through the bays 312A, 312B that may be additionally beneficial for cooling (e.g., eddy and recirculation patterns, as also discussed above).

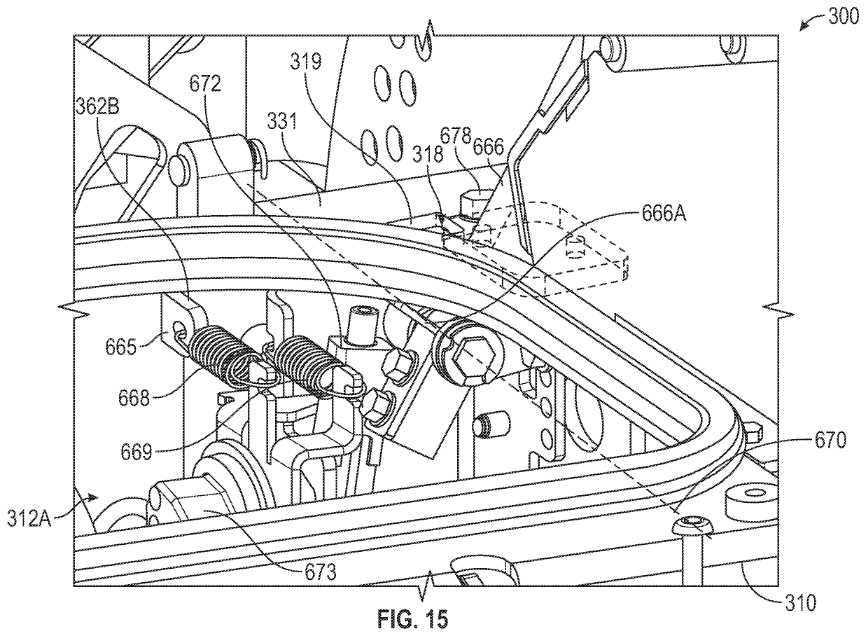

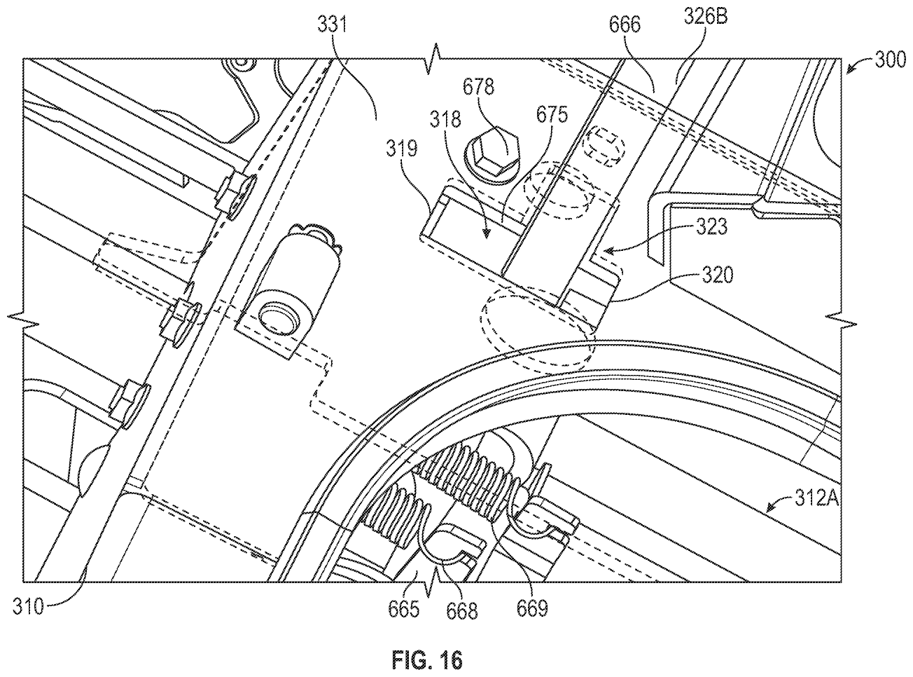

Continuing, with reference to FIGS. 15 and 16, examples of the disclosed technology can also provide for improved systems and methods for adapting to different neutral positions of a control lever of a control assembly (e.g., an operator input device). For example, the mower 300 can include substantially identical (but mirror image) left and right control assemblies 362A, 362B (see, e.g., FIG. 6) to allow for skid-steer tractive control of the mower 300. Similar to the input devices 262, the control assemblies 362A, 362B include corresponding left- and right-side control levers 664, 666 that can be independently moved by an operator to direct, respectively, rotation of left- and right-side traction motors 326 for independently commanded rotation of left- and right-side tractive elements (e.g., the drive wheels 342, see FIG. 6). Accordingly, while the discussion below only refers to the right control assembly 362B, the discussion is equally applicable to the left control assembly 362A.

With continued reference to FIGS. 15 and 16, the control assembly 362B includes a control assembly body 665 (e.g., that is disposed in the first bay 312A), which operatively supports the control lever 666. The control lever 666 extends from the control assembly body 665 and through an opening in a guide plate 331 of the main frame 310 so that an operator can manipulate the control lever 666 to control rotation of the corresponding traction motor 326 and to control a parking brake of various known designs (not shown). The guide plate 331 can be a separate plate that is secured to the frame 310 or can be formed as an integral portion of a larger component of the frame 310.

In general, a control assembly can be configured to maintain a control lever in first position (i.e., neutral position) that corresponds with a neutral drive state of a mower. In the neutral position, the control assembly does not command a corresponding drive motor to rotate to propel the mower. An operator can then apply a force to the control lever to move the control lever away from the neutral position, causing the control assembly to command a rotation of a drive motor. When the force is removed, the control lever can automatically reattain the neutral position.

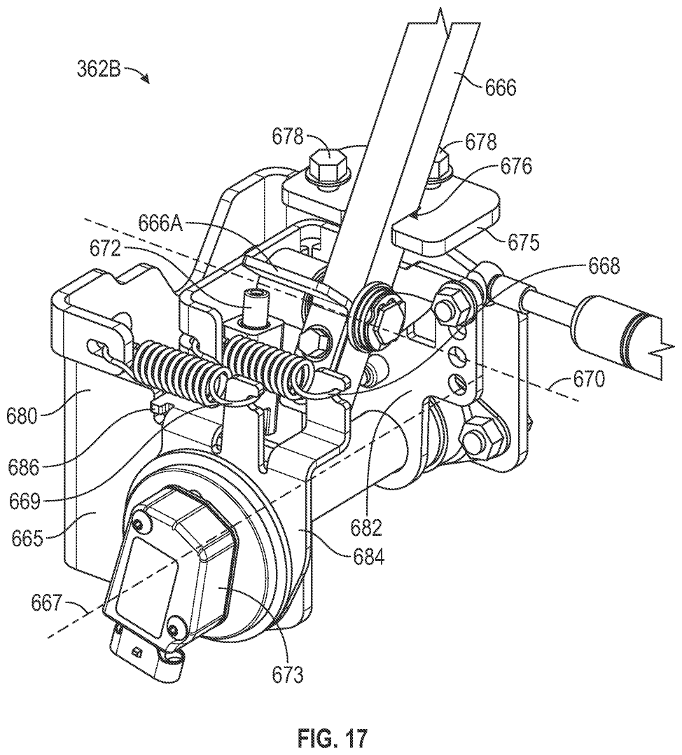

For example, with additional reference to FIG. 17, an operator can pivot the control lever 666 about a first axis 667 to move the control lever 666 in a front-to-back direction to control a drive function of the mower 300 (e.g., to control rotation of the corresponding drive motor 326 and wheel 342). Specifically, the control lever 666 can be pivoted in a first rotational direction to move the control lever 666 forward and away from a neutral position (e.g., to rotate the traction motor 326 to apply a forward force) or in a second rotational direction to move the control lever 666 rearward and away from a neutral position (e.g., to rotate the traction motor 326 to apply a rearward force). To return the control lever 666 to the neutral position, the control assembly 362B can include a pair of counteracting resilient members 668, 669 (e.g., springs, shown connected in FIG. 15) that are configured to apply a force to the control lever 666 to return it to the neutral position. As discussed in greater detail below, variation in spring rates and manufacturing tolerances of the control assembly body 665 can cause the specific neutral position of the control lever 666 to vary.

For example, still referring to FIG. 17, the control assembly body 665 includes a first bracket 680 that is configured to fixedly couple to the frame 310, and a second bracket 682 and a third bracket 684 that are pivotally coupled to the first bracket 680 to rotate about the first axis 667. As illustrated, the second bracket 682 operatively supports the control lever 666. To control movement of the second and third brackets 682, 684 relative to the first bracket 680 and one another, the first resilient member 668 is coupled between the second bracket 682 and the third bracket 684, and the second resilient member 669 is coupled between the first bracket 680 and the third bracket 684.

Depending on the rotational direction of the control lever 666, the second bracket 682 can rotate together with the third backet 684 or relative to the third bracket 684. For example, when the control lever 666 is rotated in the first rotational direction to move the control lever 666 forward, the first and second brackets 682, 684 may begin to rotate together with the control lever 666 about the first axis 667 until a stop 686 of the third bracket 684 contacts the first bracket 680. Contact between the stop 686 and the first bracket 680 prevents further rotational movement of the third bracket 684 while permitting the second bracket 682 to continue rotating relative to the third bracket 684 in the first rotational direction. This relative rotation between the second and third brackets 682, 684 stretches the first resilient member 668. Accordingly, when an operator ceases applying a force to the control lever 666, the first resilient member 668 retracts to rotate the second bracket 682 back in the second rotational direction, thereby moving the control lever 666 back to the neutral position. The spacing of the connections between the first resilient member 668 and each of the second and third brackets 682, 684 and spring rate of the first resilient member 688 can vary due to manufacturing tolerances, which can affect the location of the neutral position.

Correspondingly, when the control lever 666 is rotated in the second rotational direction to move the control lever 666 rearward, the first and second brackets 682, 684 are rotated together with the control lever 666 about the first axis 667 (e.g., to relative to the first bracket 680). This relative rotation between the first and third brackets 680, 684 stretches the second resilient member 669 so that, when an operator ceases applying a force to the control lever 666, the second resilient member 669 retracts to rotate the second and third brackets 682, 684 back in the first rotational direction, thereby moving the control lever 666 back to the neutral position. Accordingly, because the spacing of the connections between the second resilient member 669 and each of the first and third brackets 680, 684 and spring rate of the second resilient member 689 can vary due to manufacturing tolerances, the location of the neutral position can also vary.

To accommodate pivoting of the control lever 666 about the first axis 667, and as shown in FIG. 16 in particular, the guide plate 331 includes a first slot 318 that extends in a front-to-back direction between a first end 319 (i.e., a front end) and a second end 320 (i.e., a rear end). Further, the first slot 318 is positioned so that the neutral position of the control lever 666 is between the first end 319 and the second end 320, allowing for pivoting in both directions. Accordingly, an operator can move the control lever 366 away from the neutral position and toward the first end 319 of the first slot 318 to rotate the traction motor 326 in a first direction, or toward the second end 320 of the first slot 318 to rotate the traction motor 326 in a second direction.

Still referring to FIG. 17, an operator can pivot the control lever 666 about a second axis 670 to move the control lever 366 laterally to control a parking brake function of the mower 300 (e.g., to engage or disengage a parking brake). More specifically, the control lever 666 can be moved between an inboard position that corresponds with a drive state of the mower 300 and an outboard position that corresponds with a parking state of the mower 300. In the drive state, a protrusion 666A on the control lever 666 contacts a brake switch 672, thereby deactivating a parking brake and allowing a traction motor to be operated by the control assembly 362B. In the parking state, the protrusion 666A is moved by the lever 666 out of contact with the brake switch 672 (i.e., to release the brake switch), thereby activating the parking brake and preventing any traction motors from being operated by the control assembly 362B. In some examples, particularly, where multiple control assemblies or multiple brake switches are provided, one or more (e.g., all) parking brakes of a mower can be deactivated only when all brake switches are activated. Accordingly, only one brake switch may need to be released to activate all parking brakes of the mower.

In general, it can be beneficial to restrict lateral movement of a control lever so that the parking brake can only be engaged when the control lever is in the neutral position. Accordingly, in the illustrated example, the first slot 318 can be size to prevent lateral movement of the control lever 666 when the control lever 666 is moved away from a neutral position. Correspondingly, the guide plate 331 further includes a second slot 323 extending laterally from an outboard side of the first slot 318. The second slot 323 is positioned between the first end 319 and the second end 320 to align with the natural neutral position of the control lever 666. Thus, from the neutral position, the control lever can be moved laterally from an inboard position within the first slot 318 to an outboard position in the second slot 323 to engage the parking brake of the mower 300 (e.g., to release the brake switch 672). Further, when the control lever 666 is not aligned to be moved into the second slot 323, engagement of the parking brake is generally prevented.

In some cases, for example, the exact neutral position of a control lever can vary relative to the first and second ends of a first slot due to variability in manufacturing. Accordingly, a second slot in a guide plate in conventional designs may need to be oversized to accommodate a range of possible neutral positions (i.e., to ensure that the control lever can be moved into the second slot from the neutral position, to engage the parking brake). Additionally, a position sensor (e.g., a position sensor 673) for determining when the control lever is not in a neutral position (e.g., to drive a traction motor) may need to be configured to have a wide neutral band (i.e., a range of positions around true neutral position), in which the control lever can be considered to be in the neutral position, so that slight pivoting about the axis 667 when the lever is within the oversized second slot does not result in a commanded tractive movement while the parking brake is still engaged.

Thus, to reduce the width of the neutral band or otherwise improve perceived responsiveness of a control assembly, and to ensure alignment of a control lever neutral position with the second slot, a control assembly can include an adjustment plate that is secured to the guide plate. In particular, the adjustment plate can effectively narrow and adaptably bound the second slot along the first slot, so that an effectively narrower second slot can be provided in relatively close alignment with a true neutral position. For example, with additional reference to FIG. 18, the control assembly 362 can further include an adjustment plate 675 with a third, open slot 676 having a width (i.e., a front-to-back dimension) that is smaller than a corresponding width of the second slot 323. As a result, the third slot 676 extends laterally from the first slot 318 to define a sub-slot within the second slot 323 that can be customizably more closely aligned with the exact neutral position of the control lever 666.

In some cases, an adjustment plate can also be selectively adjustable relative to a second slot of a guide plate to adjust a front to back position of a third slot within the second slot. For example, the guide plate 331 can define one or more elongated attachment slots 328 that extend in a front to back direction. Additionally, the adjustment plate 675 can include correspondingly holes 677 that can be aligned with the elongated attachment slots 328. Fasteners 678 can then be inserted through the elongated attachment slots 328 and holes 677 to secure the adjustment plate 675 in a desired position that corresponds with the natural neutral position of the control lever 666. In other examples, elongated attachment slots can be provided on the adjustment plate and holes can be provided on the guide plate.

To align the third slot 676 within the second slot 323, the control assembly body 665 and the control lever 666 can first be installed on the main frame 310 (e.g., as a single unit or separately). Where the guide plate 331 is a separate component, the guide plate 331 can be attached to the frame 310. Alternatively, if the guide plate 331 is integral with the frame, the control lever 666 can be inserted through the guide plate 331, after which the control assembly body 665 can be secured to the frame 310.

Subsequently, with the control lever 666 in its neutral position, the control lever 666 can then be moved laterally outward into the second slot 323. With the control lever 666 in the second slot 323, and still in the neutral position, the adjustment plate 675 can then be fitted around the control lever 666 so that the control lever 666 is received in the third slot 676. Fasteners 678 can then be inserted through the aligned elongated attachment slots 328 and holes 677 to secure the adjustment plate 675 in position (see FIGS. 15-17). Thus, the third slot 676 forms a sub-slot in the second slot 323 that more closely aligns with the true neutral position of the control lever 666, and the need for a relatively wide neutral band can be correspondingly reduced.

Continuing, with reference to FIGS. 19-21, the disclosed technology can also provide improved systems and methods for cutting assemblies of a mower. In particular, aspects of the disclosed technology can be advantageously practiced with direct drive cutting assemblies having rotating blades that are directly operatively coupled to rotate with a spindle of a cutting motor (e.g., as opposed to conventional, belt drive arrangements where a cutting motor is operatively coupled to a blade via a belt or other indirect coupling). As mentioned above, the mower 300 includes three cutting assemblies 332 (see FIGS. 6 and 19), which are generally identical to one another (or can vary in size and mounting arrangement, but not in general mounting or torque-transmission structure). Accordingly, while only a single cutting assembly is described below, the discussion applies equally to the other cutting assemblies.

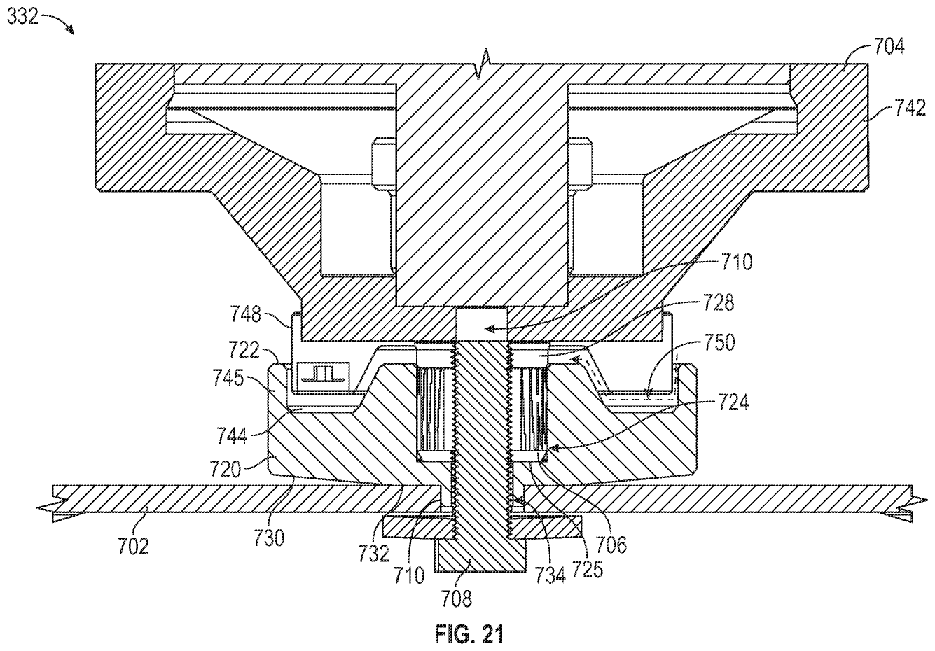

Still referring to FIGS. 19-21 the illustrated cutting assembly 332 is configured as a direct drive cutting assembly with a blade 702 that is directly coupled to rotate with a cutting motor 704. As best shown in FIG. 21, the blade 702 can be coupled at a distal end of a spindle 706 (i.e., an output shaft) of the cutting motor 704 by a fastener 708. More specifically, the fastener 708 can be inserted through a hole 710 in the blade 702 and into a central hole of the spindle 706. The fastener 708 can then be tightened to secure the blade 702 the spindle 706. Accordingly, rotation of the spindle 706 directly rotates the blade 702 so that the cutting assembly 332 can cut, for example, plant material.

However, during a cutting operation, it is possible that a blade of a cutting assembly can contact a generally immovable object that is not intended to or cannot be cut by a blade (e.g., tree stumps, rocks, pipes, etc.) Contact with generally immovable objects can result in large inertial loads (i.e., transmitted torque) being applied to the blade and motor. Thus, to provide protection against large inertial loads, a direct drive cutting assembly can be fitted with an adapter that can help to reduce the load imparted to a motor in certain contexts. In particular, an adapter can serve as an interface between a motor spindle and a blade, which can allow for both slip and non-slip interfaces that can provide for both non-destructive and destructive yielding connections, respectively. Thus, in some cases, excessive torque on a blade during operation can be accommodated by non-destructive yielding or destructive yielding, depending on the magnitude of the relevant force.

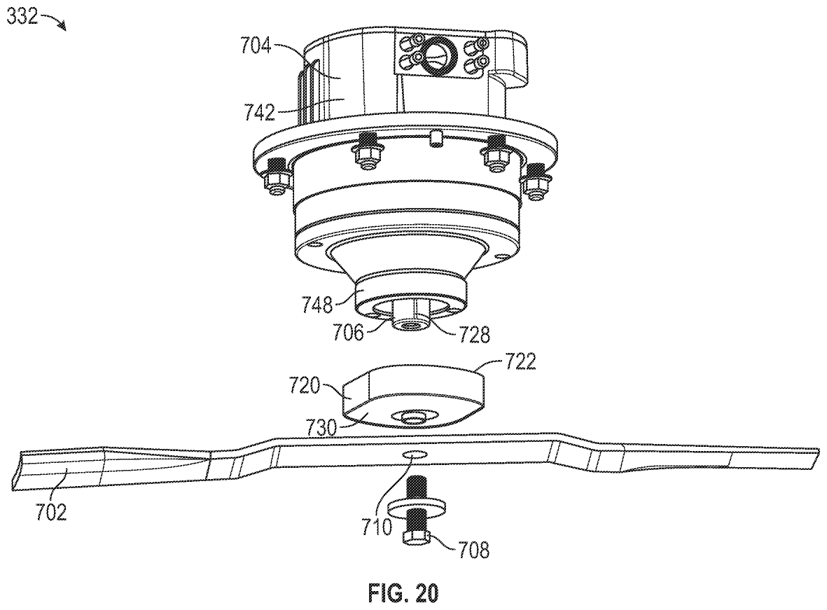

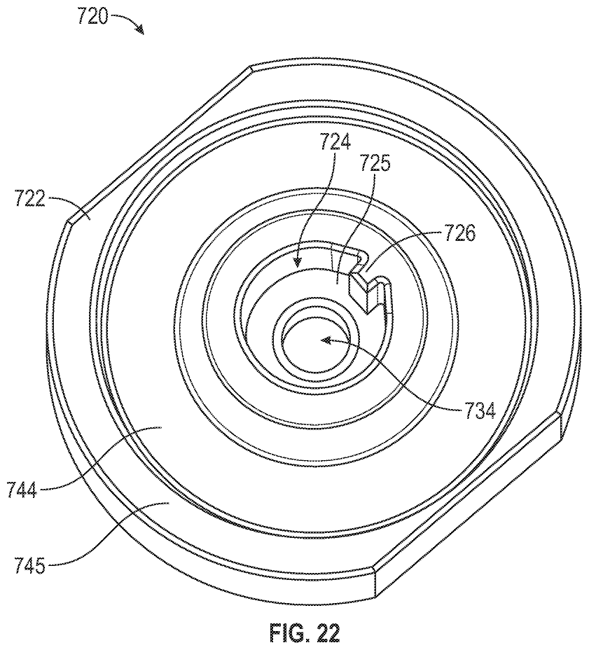

For example, as best shown in FIGS. 20-22, the cutting assembly 332 can include an adapter 720 that is coupled between the blade 702 and the spindle 706. The adapter 720 includes a first side 722 with a recess 724 that is configured to fit over the spindle 706 so that a bottom 725 of the recess 724 is in contact with the distal end of the spindle 706 (e.g., to be between the spindle 706 and the blade 702). As best shown in FIG. 22, a protrusion 726 extends (radially) into the recess 724 to engage with a corresponding slot 728 formed in the spindle 706, thereby providing a first (mechanical) connection that rotationally locks the adapter 720 with the spindle 706. To that end, the protrusion 726 functions as a key that forms a keyed connection with the slot 738 in spindle 706. In other examples, other types of connections can be used to rotationally lock the adapter 720 with the spindle 706, for example, a splined, pinned, or press fit connection.

To protect the motor 704, the protrusion 726 can be sized to destructively yield (i.e., shear or otherwise break) at a first maximum torque transmission value for transmission of operational torque between the motor 704 and the adapter 720. When the protrusion 726 destructively yields, the adapter 720 is no longer rotationally locked with the spindle 706. As a result, the spindle 706 can rotate independently of the adapter 720 so that torque is not transmitted therebetween. In this way, the adapter 720 acts as a sacrificial component that is intended to break in order to prevent greater or more costly damage to the motor 704.

Additionally, the adapter 720 also includes a second side 730 opposite the first side 722 (see FIG. 21). The second side 730 defines a contact area 732 that is configured to frictionally engage the blade 702 to transmit force from the spindle 706, thereby providing a second (frictional) connection between the blade 702 and the adapter 720. Accordingly, the adapter 720 can include a through hole 734 to allow the fastener 708 to pass through the adapter 720 to engage with the spindle 706.

To protect the cutting motor 704, the second connection can be configured to non-destructively yield (e.g., to slip or otherwise resiliently deform) at a second maximum torque transmission value for transmission of operational torque between the blade 702 and the adapter 720. While the second connection non-destructively yields (e.g., when the torque is at or above the second maximum torque transmission value), some torque may still be transmitted from the blade 702 to the motor 704 via the adapter 720, but at a reduced magnitude. This can substantially lower the risk of damage to the motor 704. Subsequently, when the torque drops below the second maximum torque transmission value the blade 702 and motor 704 can generally continue to rotate together under normal cutting operation conditions (i.e., due to the non-destructive nature of the yielding). The specific second maximum torque transmission value can be set by sizing the contact area 732 in combination with the torque of the fastener 708 to provide a desired normal force between the adapter 720 and the blade 702 when the blade 702 is secured for operation by the fastener 708 so as to compress the blade 702 between the fastener 708 and the adapter 720. In some examples, the adapter 720 can be made of a sintered metal material to allow slip contact without significant wear on the blade 702 or the contact area 732 of the adapter 720.

In general, the second maximum torque transmission value can be less than the first maximum torque transmission value. In this way, the second connection can allow for non-destructive yielding for torque transmission values between the second maximum torque transmission value and the first maximum torque transmission value. Correspondingly, only once the torque transmission value reaches the first maximum torque transmission value does destructive yielding occur. Further, both the second maximum torque transmission value and the first maximum torque transmission value can be greater than a maximum rated motor torque (i.e., a third maximum torque transmission value) so that blade 702 can spin with the motor 704 under normal operational conditions without slippage of the blade 702 and without having to repair or replace the adapter 720.

Further still, some types of motors can include over-torque protection function that stops the motor from operating at an over-torque protection limit (i.e., a fourth maximum torque transmission value). Accordingly, the both the second maximum torque transmission value and the first maximum torque transmission value can be greater than the over-torque protection limit to allow for the over-torque protection function to first attempt to stop the motor 704 from spinning if the transmitted torque is over the over-torque protection limit or if the blade 702 is prevented from rotating at all.

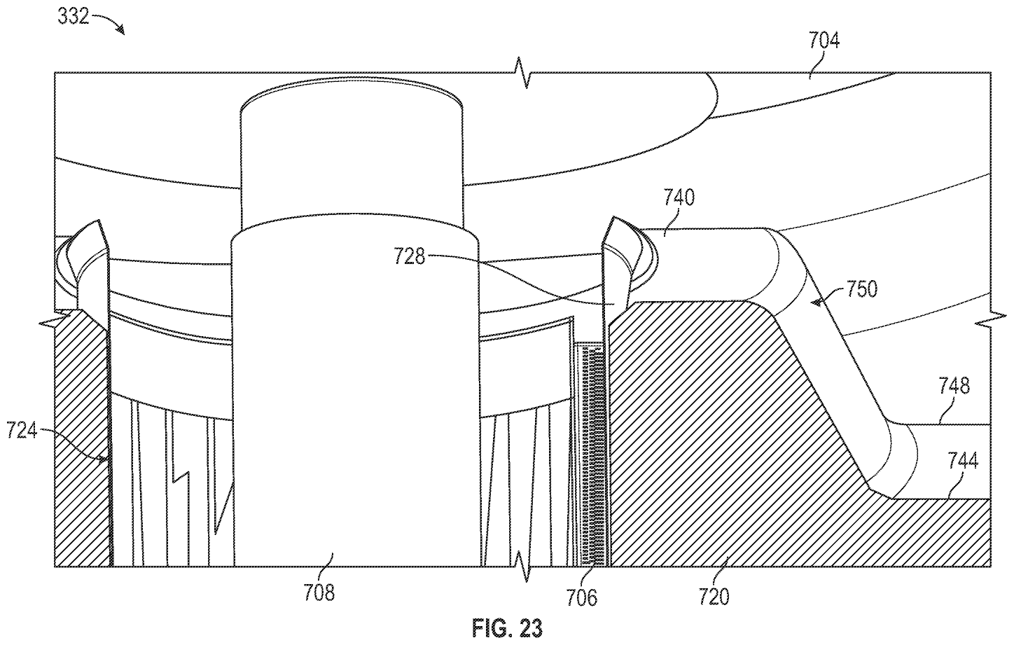

In some examples, an adapter can also aid in preventing ingress of debris into a motor. For example, referring to FIG. 23, the motor 704 generally includes a lip seal 740 positioned between the spindle 706 and a motor housing 742. While the lip seal 740 does help prevent debris from entering the motor housing 742 where it can damage sensitive internal component, it is possible that very fine particles can still enter the motor housing 742. Referring also to FIG. 21, to help prevent fine particles from reaching the lip seal 740, the adapter 720 can include an annular recess 744 surrounding the central recess 724 that fits over and receives the spindle 706. Correspondingly, adapter 720 also includes an outer lip 745 on a radially exterior side of the annular recess 744. The annular recess 744 can be sized to fit over an output interface 748 of the motor 704, so that a non-linear path 750 is defined for any ingress of debris past the adapter 720 into the motor 704. This non-linear nature of the path 750 can function similarly to a labyrinth seal to help prevent debris from reaching the lip seal 740 and entering the motor housing 742.

In some examples, aspects of the disclosed technology, including computerized implementations of methods according to the disclosed technology, can be implemented as a system, method, apparatus, or article of manufacture using standard programming or engineering techniques to produce software, firmware, hardware, or any combination thereof to control a processor device (e.g., a serial or parallel general purpose or specialized processor chip, a single- or multi-core chip, a microprocessor, a field programmable gate array, any variety of combinations of a control unit, arithmetic logic unit, and processor register, and so on), a computer (e.g., a processor device operatively coupled to a memory), or another electronically operated controller to implement aspects detailed herein. Accordingly, examples of the disclosed technology can be implemented as a set of instructions, tangibly embodied on a non-transitory computer-readable media, such that a processor device can implement the instructions based upon reading the instructions from the computer-readable media. Some examples of the disclosed technology can include (or utilize) a control device such as an automation device, a special purpose or general purpose computer including various computer hardware, software, firmware, and so on, consistent with the discussion below. As specific examples, a control device can include a processor, a microcontroller, a field-programmable gate array, a programmable logic controller, logic gates etc., and other typical components that are known in the art for implementation of appropriate functionality (e.g., memory, communication systems, power sources, user interfaces and other inputs, etc.). In some examples, a control device can include a hub controller, i.e., a central controller that receives, processes and (re)transmits control signals and other data to and from other distributed control devices (e.g., an engine controller, an implement controller, a drive controller, etc.), including as part of a hub-and-spoke architecture or otherwise.

The term “article of manufacture” as used herein is intended to encompass a computer program accessible from any computer-readable device, carrier (e.g., non-transitory signals), or media (e.g., non-transitory media). For example, computer-readable media can include but are not limited to magnetic storage devices (e.g., hard disk, floppy disk, magnetic strips, and so on), optical disks (e.g., compact disk (CD), digital versatile disk (DVD), and so on), smart cards, and flash memory devices (e.g., card, stick, and so on). Additionally, it should be appreciated that a carrier wave can be employed to carry computer-readable electronic data such as those used in transmitting and receiving electronic mail or in accessing a network such as the Internet or a local area network (LAN). Those skilled in the art will recognize that many modifications may be made to these configurations without departing from the scope or spirit of the claimed subject matter.

Certain operations of methods according to the disclosed technology, or of systems executing those methods, may be represented schematically in the FIGS., or otherwise discussed herein. Unless otherwise specified or limited, representation in the FIGS. of particular operations in particular spatial order may not necessarily require those operations to be executed in a particular sequence corresponding to the particular spatial order. Correspondingly, certain operations represented in the FIGS., or otherwise disclosed herein, can be executed in different orders than are expressly illustrated or described, as appropriate for particular examples of the disclosed technology. Further, in some examples, certain operations can be executed in parallel, including by dedicated parallel processing devices, or separate computing devices configured to interoperate as part of a large system.

As used herein in the context of computer implementation, unless otherwise specified or limited, the terms “component,” “system,” “module,” “block,” “device,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

As used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

As also used herein in the context of a power machine, unless otherwise defined or limited, the term “lateral” refers to a direction that extends at least partly to a left or a right side of a front-to-back reference line defined by the power machine. Accordingly, for example, a lateral side wall of a cab of a power machine can be a left side wall or a right side wall of the cab, relative to a frame of reference of an operator who is within the cab or is otherwise oriented to operatively engage with controls of an operator station of the cab. Similarly, a “centerline” of a power machine refers to a reference line that extends in a front-to-back direction of a power machine, approximately half-way between opposing lateral sides of an outer spatial envelope of the power machine. Also as used herein, the terms “about” and “approximately” mean plus or minus 5% of the number that each term precedes, unless otherwise specified.

As also used herein, unless otherwise defined or limited, the terms “inboard” and “outboard” refer to a relative relationship (e.g., a lateral distance) between one or more objects or structures and a centerline of the power machine, along a lateral side of the power machine. For example, a first structure that is inboard of a second structure is positioned laterally inward from the second structure so that a distance between the first structure and the centerline of the power machine is less than a distance between the second structure and the centerline of the power machine. Conversely, a first structure that is outboard of a second structure is positioned laterally outward from the second structure so that a distance between the first structure and the centerline of the power machine is greater than a distance between the second structure and the centerline of the power machine.

Also as used herein, unless otherwise limited or defined, “substantially parallel” indicates a direction that is within ±5 degrees of a reference direction (e.g., within ±3 degrees or ±2 degrees), inclusive. Correspondingly, “substantially vertical” indicates a direction that is substantially parallel to the vertical direction, as defined relative to the reference system (e.g., for a power machine, as defined relative to a horizontal support surface on which the power machine is operationally situated), with a similarly derived meaning also for “substantially horizontal.” Unless otherwise limited or defined, “substantially perpendicular” indicates a direction that is within ±12 degrees of perpendicular a reference direction (e.g., within ±6 degrees or ±3 degrees), inclusive.

As used herein, unless otherwise defined or limited, two components that are described herein as “substantially aligned” are aligned along a particular reference direction (e.g., a front-to-back direction) across more than half of a dimension of at least one the components in a direction orthogonal to the reference direction. Two components that are described herein as being “aligned” vertically above or below one another are aligned at a common lateral distance from a common reference (e.g., a centerline of a power machine, with one component position directly above the other). Thus, for example, where two components are “aligned” vertically above or below one another, a vertical line passing through one component will intersect the other component. A component that is described as being “located” or “positioned” vertically above or below a reference component) is arranged at a different vertical height than the reference component relative to a common reference frame (e.g., at a higher or lower height relative to ground), but is not necessarily laterally aligned with the reference component. Accordingly, where a first component is located or arranged vertically above or below a second component, a vertical line through the first component may not necessarily extend through the second components (e.g., no vertical line through the first component may intersect the second component).

Also, unless otherwise specified or limited, the terms “about” and “approximately,” as used herein with respect to a reference value, refer to variations from the reference value of ±15% or less (e.g., ±10%, ±5%, etc.), inclusive of the endpoints of the range. Similarly, the term “substantially equal” (and the like) as used herein with respect to a reference value refers to variations from the reference value of less than ±30% (e.g., ±20%, ±10%, ±5%) inclusive. Where specified, “substantially” can indicate in particular a variation in one numerical direction relative to a reference value. For example, “substantially less” than a reference value (and the like) indicates a value that is reduced from the reference value by 30% or more, and “substantially more” than a reference value (and the like) indicates a value that is increased from the reference value by 30% or more.

As used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

In some implementations, devices or systems disclosed herein can be utilized, manufactured, installed, etc. using methods embodying aspects of the disclosed technology. Correspondingly, any description herein of particular features, capabilities, or intended purposes of a device or system is generally intended to include disclosure of a method of using such devices for the intended purposes, of a method of otherwise implementing such capabilities, of a method of manufacturing relevant components of such a device or system (or the device or system as a whole), and of a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as examples of the disclosed technology, of the utilized features and implemented capabilities of such device or system.

Although the presently disclosed technology has been described with reference to preferred examples, workers skilled in the art will recognize that changes may be made in form and detail to the disclosed technology without departing from the spirit and scope of the concepts discussed herein.

What is claimed is:

1. A mower comprising:
a main frame that includes a first electronics bay and a second electronics bay;
a cutting assembly supported by the main frame to cut plant material during operation of the mower;
one or more first power electronic devices housed within the first electronic bay; and
an electrical power source and one or more second power electronic devices housed within the second electronics bay,
wherein a flow path for a cooling airflow is defined by the mower to extend from an air inlet, through the first electronics bay to the second electronics bay, and from the second electronics bay to an air outlet.

2. The mower of claim 1, wherein the air inlet provides an upward air flow along the flow path from outside the mower to an interior space of the mower; and
wherein the air outlet provides a downward air flow along the flow path from the second electronics bay to outside the mower.

3. The mower of claim 2, wherein the air inlet is disposed on a bottom side of the main frame; and wherein the air inlet is separated from the first electronics bay by one or more baffle walls to provide the upward air flow.

4. The mower of claim 2, further comprising:
an outlet fan supported at a bottom wall of the second electronics bay and arranged to direct the downward air flow to be vented away from the mower through the air outlet.

5. The mower of claim 4, wherein the one or more second power electronic devices include a first charger for the electrical power source, arranged to a rear side of the electrical power source; and
wherein the outlet fan is located vertically below the first charger to direct the downward air flow past the first charger.

6. The mower of claim 5, wherein one or more second power electronic devices further include a second charger for the electrical power source that is spaced laterally from the first charger to define a vertical flow channel for the downward air flow;
wherein the vertical flow channel extends along the flow path, between the first and second chargers, to the outlet fan.

7. The mower of claim 1, wherein the electrical power source is disposed between the one or more first power electronic devices in the first electronics bay and the one or more second power electronic devices in the second electronics bay; and
wherein the flow path includes a power-source cooling sub-path that extends from the first electronics bay to the one or more second power electronics devices in the second electronics bay, the power-source cooling sub-path extending one or more of: over a top side of the electrical power source, or around one or more lateral sides of the electrical power source.

8. The mower of claim 7, wherein the first electronics bay is aligned vertically below an operator seat.

9. A method of cooling a power machine, the method comprising:
operating a fan at a rear end of the power machine to cause a cooling airflow from a cooling inlet of the power machine to the fan, the cooling inlet being at a front end of the power machine;
wherein, along a cooling flow path between the cooling inlet and the fan, the cooling airflow:
flows upwardly from the cooling inlet;
circulates within a first locally enlarged area that houses first electronics of the power machine and is downstream of the cooling inlet;
passes through a cooling restriction that is downstream of the first locally enlarged area, the cooling restriction being defined at least in part by a power source of the power machine that is arranged to be cooled by the cooling airflow;
circulates within a second locally enlarged area that houses second electronics of the power machine; and
flows downwardly to the fan to be directed to an ambient surroundings to reject heat from the first and second electronics and the power source.

10. The method of claim 9, wherein the power machine is a mower with a cutting assembly; and
wherein the cooling inlet is aligned vertically above the cutting assembly.

11. The method of claim 10, wherein the first locally enlarged area is aligned vertically below an operator seat of the mower.

12. The method of claim 9, wherein the power source is an electrical power source; and
wherein the cooling restriction defines a flow area for the cooling airflow to flow along at least one of: a top side of the electrical power source, or one or more lateral sides of the electrical power source.

13. The method of claim 12, wherein the power machine includes one or more electronic drive motors; and
wherein the cooling restriction defines the flow area for cooling airflow along the one or more lateral sides of the electrical power source, so that the flow area extends along the one or more electronic drive motors so that the cooling airflow cools the one or more electronic drive motors along the cooling restriction.

14. The method of claim 9, wherein the power source is a rechargeable electrical power source;
wherein the second electronics includes a charger for the rechargeable electrical power source, the charger being arranged to the rear of the rechargeable electrical power source; and
wherein the fan is automatically controlled to continuously provide the cooling airflow during operation of the charger to charge the rechargeable electrical power source.

15. The method of claim 14, wherein the power machine is a mower with a cutting assembly; and
wherein the fan is automatically controlled to provide the cooling airflow based on one or more cooling criteria for one or more of a motor, an inverter, or an electrical power source of the mower.

16. A mower comprising:
a main frame;
a drive assembly supported by the main frame and including one or more electric drive motors;
a cutting assembly including one or more electric cutting motors, the cutting assembly being supported by the main frame to cut plant material during operation of the mower;
an electrical power source configured to provide operational power for the one or more electric drive motors and the one or more electric cutting motors, and
a charger supported on the main frame to charge the electrical power source using current from an external power source.

17. A sub-assembly for a mower, the mower including a main frame and an electrical power source, the sub-assembly comprising:
a support plate;
a first charger for the electrical power source and a second charger for the electrical power source, wherein the first and second chargers are secured on the support plate to be collectively installed onto the mower with the support plate.

18. The sub-assembly of claim 17, further comprising:
a first charger, a second charger, a DC/DC converter, a communication module, and a hub controller secured to the support plate to be collectively installed onto the mower with the support plate.

19. The sub-assembly of claim 18, wherein, on first side of the support plate:
the hub controller is secured at a first end of the support plate,
the first charger is secured at a second end of the support plate,
the second charger is secured between the hub controller and the first charger, and
the DC/DC converter is secured between first charger and the second charger.

20. The sub-assembly of claim 19, wherein, on a second side of the support plate, the communication module is secured at the first end of the support plate and directly opposite the hub controller.
